(19) United States
(12) Patent Application Publication
(10) Pub. No.: US 2026/0359239 A1
(43) Pub. Date: Nov. 12, 2026

(54) BUFFERED DATA I/O INTERFACES

(71) Applicant: Rambus Inc., San Jose, CA (US)

(72) Inventors: Robert E. PALMER, Chapel Hill, NC (US); Evan Lawrence ERICKSON, Chapel Hill, NC (US); Torsten PARTSCH, Raleigh, NC (US)

(21) Appl. No.: 19/661,232

(22) Filed: Apr. 28, 2026

Related U.S. Application Data
(60) Provisional application No. 63/800,759, filed on May 6, 2025.
(60) Provisional application No. 63/868,723, filed on Aug. 22, 2025.

(51) Int. Cl. G06F 13/20

(52) U.S. Cl. CPC G06F 13/20; G06F 2213/40

(57) ABSTRACT

In a first mode, a memory device may be configured to independently access a first set of memory arrays of the memory device using a first data I/O interface and a second set of memory arrays of the memory device using a second data I/O interface. In a second mode, the first data I/O interface and the second data I/O interface are each divided into two one-half width portions. A first of these two portions is configured to be used to independently and respectively access the first memory arrays and the second memory arrays. A second of these two portions, is configured to be used to relay data between the memory device and another memory device (e.g., stacked with the first memory device).

### BRIEF DESCRIPTION OF THE DRAWINGS

FIGS. 1A-1J are block diagrams illustrating memory device buffering configurations.

FIGS. 2A-2E are diagrams illustrating example stacked die data buffering.

FIGS. 3A-3B are diagrams illustrating a first example data I/O buffering configuration.

FIGS. 4A-4C are diagrams illustrating a second example data I/O buffering configuration.

FIG. 5 is a flowchart illustrating a method of buffering data I/O signals.

FIG. 6 is a flowchart illustrating a method of communicating data with a controller.

FIG. 7 is a flowchart illustrating a method of communicating data via a memory die stack.

FIG. 8 is a flowchart illustrating a method of relaying data via a portion of a data I/O interface.

FIG. 9 is a block diagram of a processing system.

### DETAILED DESCRIPTION OF THE EMBODIMENTS

In an embodiment, in a first mode, a memory device may be configured to independently access a first set of memory arrays of the memory device using a first data I/O interface and a second set of memory arrays of the memory device using a second data I/O interface. In this first mode, the first data I/O interface and the second data I/O interface may be considered to be parts of different (i.e., first and second) memory channels. In a second mode, for example, the first data I/O interface and the second data I/O interface are each divided into two one-half width, relative to the first mode, portions. A first of these two portions, for each of the first data I/O interface and the second data I/O interface, is configured to be used to independently and respectively access the first memory arrays and the second memory arrays. A second of these two portions, is configured to be used to relay data between the memory device and another memory device (e.g., stacked with the first memory device). Similarly, in a third mode, for example, all of the first data I/O interface is configured to be used to access data in both the first set of memory arrays and the second set of memory arrays, while the second data I/O interface is configured to relay data between the memory device and another memory device. Other example modes with other data I/O interface access versus relay configurations are also disclosed herein.

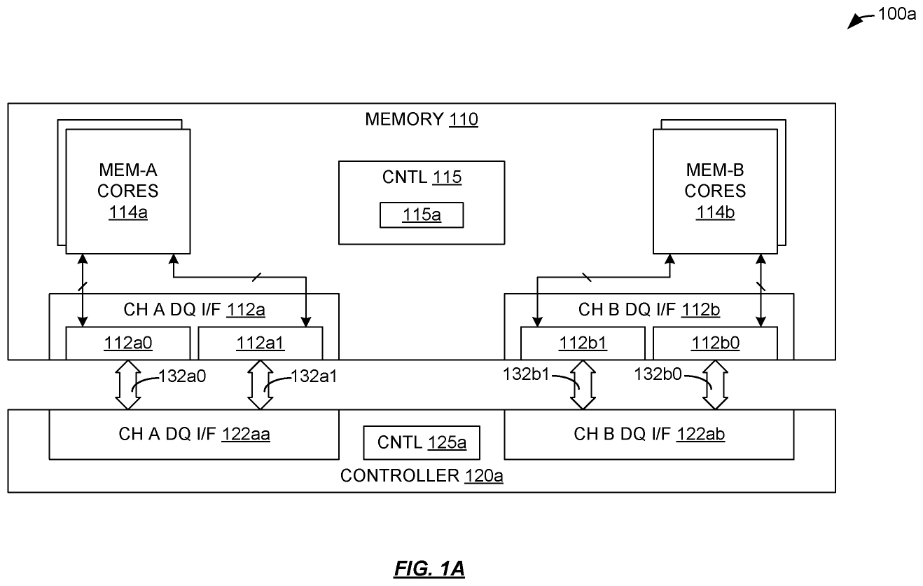

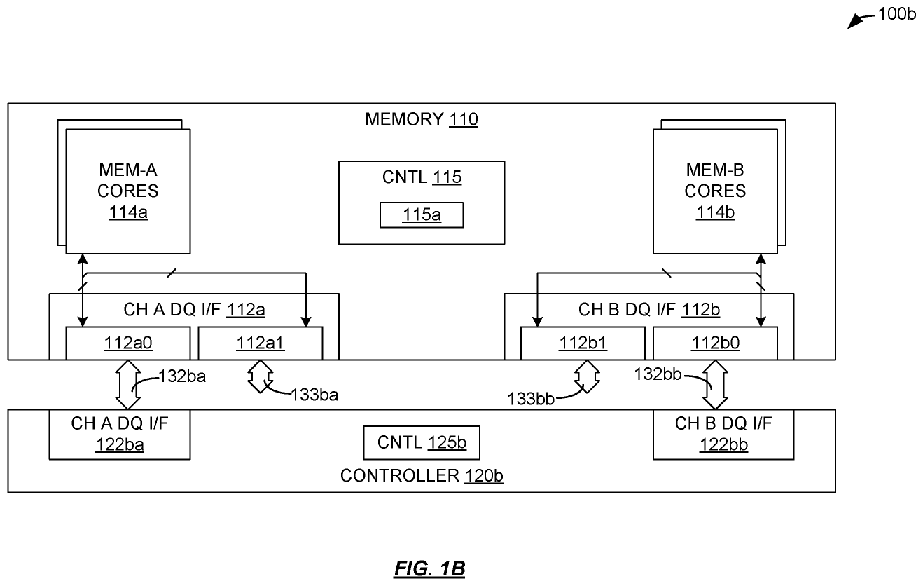

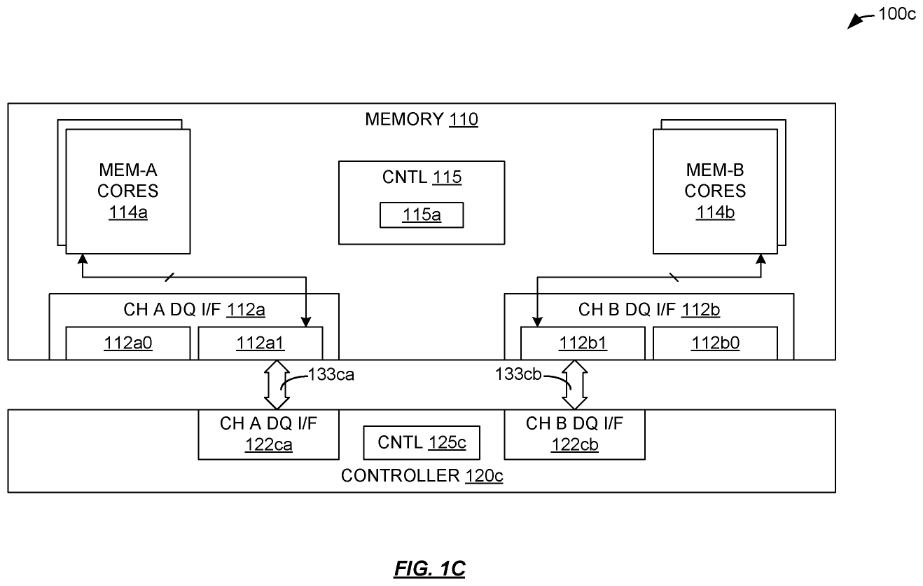

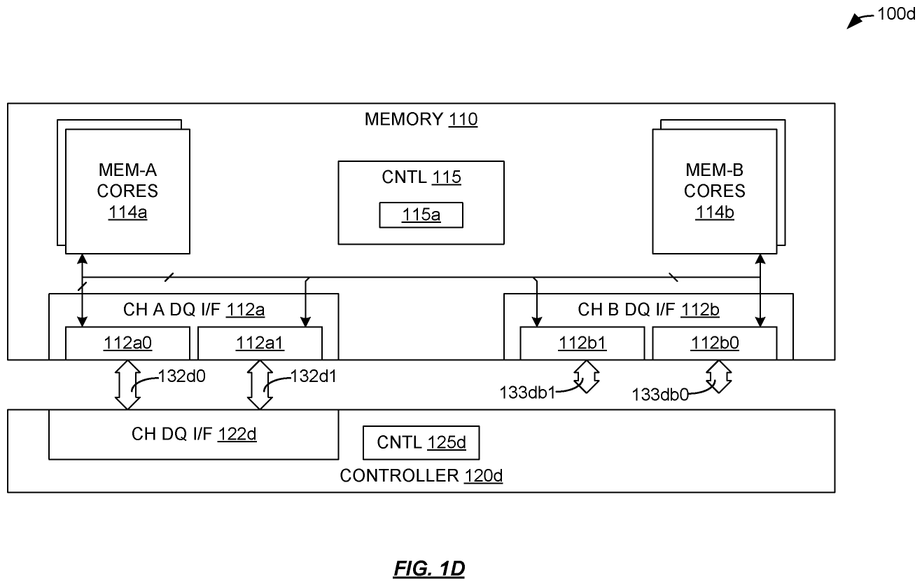

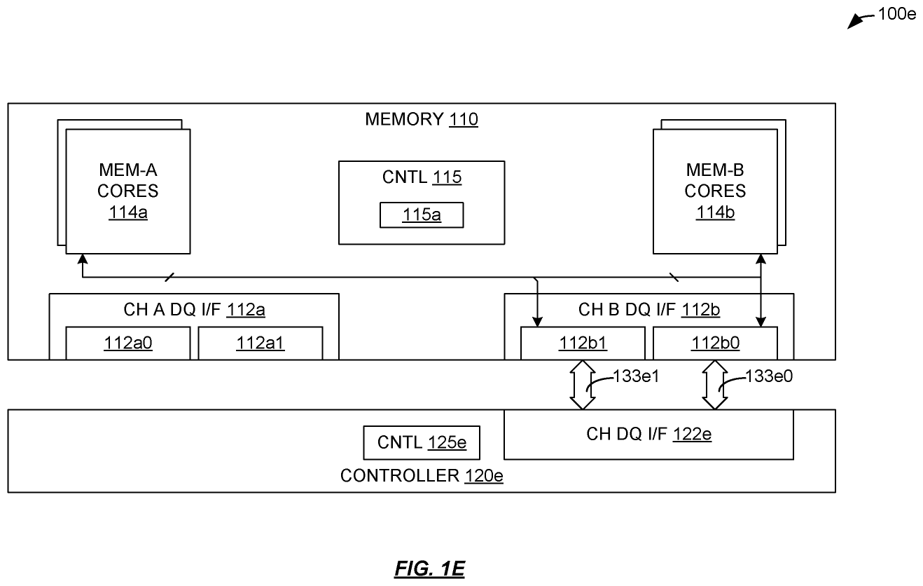

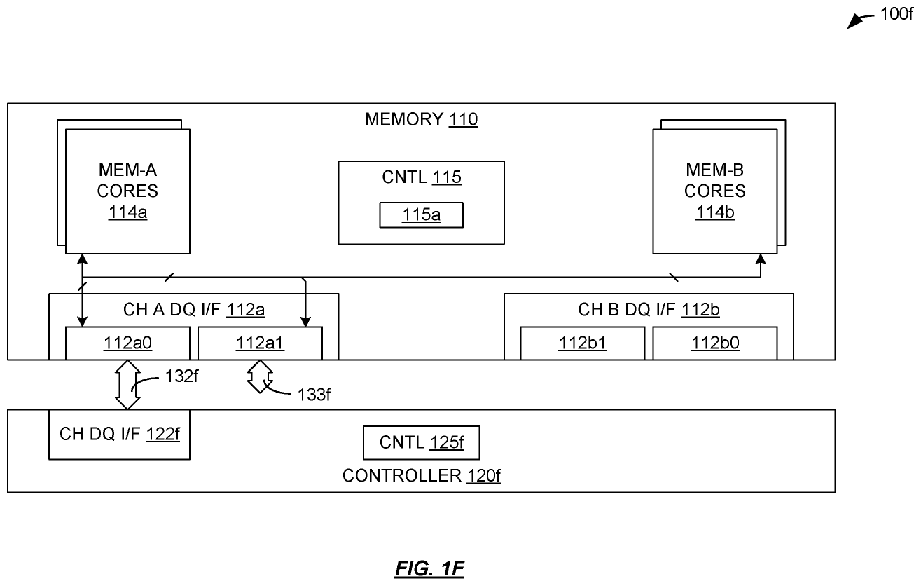

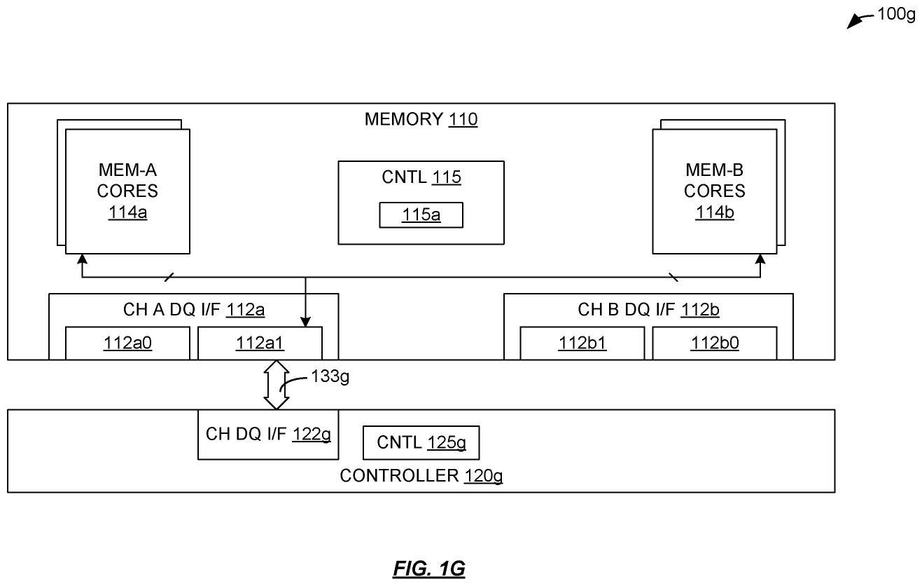

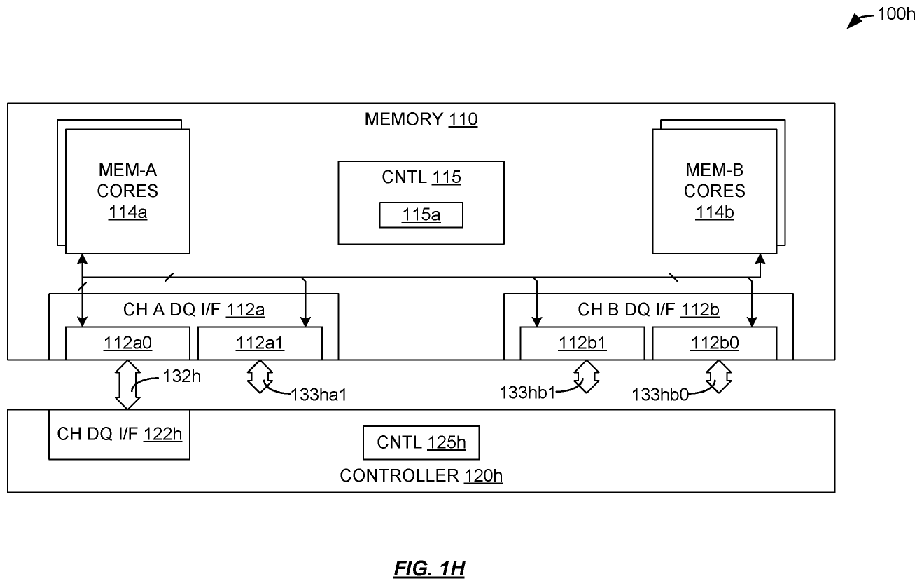

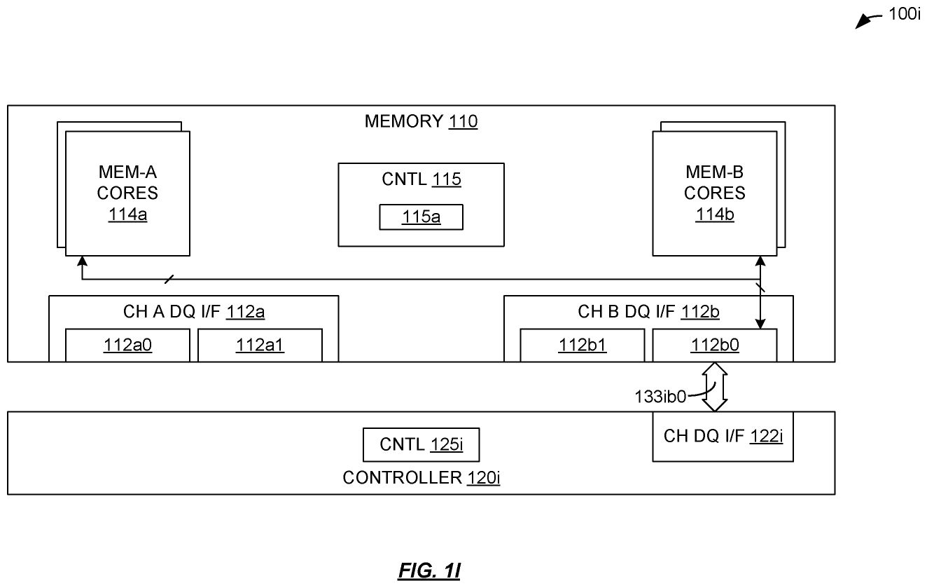

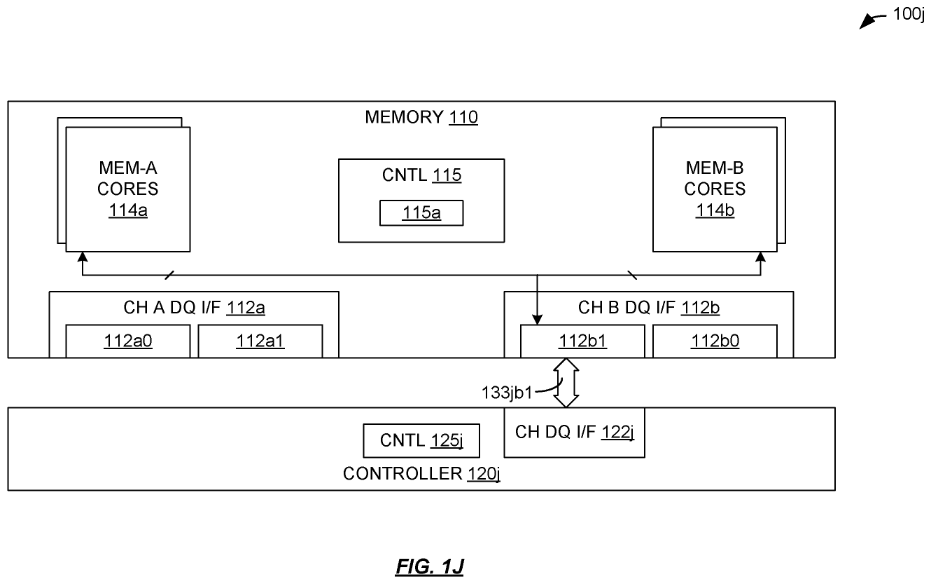

FIGS. 1A-1J are block diagrams illustrating memory device buffering configurations. In FIGS. 1A-1J, memory device 110 and controllers 120a-120j may be one or more integrated circuit type devices, such as are commonly referred to as “chips”. Controllers 120a-120i and memory device may be one or more integrated circuit type devices, such as are commonly referred to as “chips”. Memory controllers, such as controllers 120a-120j, manage the flow of data going to and from memory devices, and/or memory components such as memory modules and/or memory device stacks (e.g., High Bandwidth memory—HBM). Memory device 110 may be a standalone device, or may be a component of a memory module such as a DIMM module used in servers. In an embodiment, memory device 110 may be a device that adheres to, or is compatible with, a dynamic random access memory (DRAM) specification. In an embodiment, memory device 110 may be, or comprise, a device that is or includes other memory device technologies and/or specifications. A memory controller can be a separate, standalone chip, or integrated into another chip. For example, a memory controller 120a-120j may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

FIG. 1A illustrates a first example, mode/configuration for a memory device. In FIG. 1A, memory system 100a comprises memory device 110 and controller 120a. In FIG. 1A, controller 120a includes channel A DQ interface 122aa, channel B DQ interface 122ab, and control circuitry 125a.

In FIGS. 1A-1J, memory device 110 comprises channel “A” data (DQ) interface 112a, channel “B” DQ interface 112b, memory channel “A” arrays (a.k.a., cores) 114a, memory channel “B” arrays 114b, and control circuitry 115. Control circuitry 115 includes mode circuitry 115a. Channel A DQ interface 112a may be divided (or includes) a first set of DQ signals/signal interfaces 112a0 and a second set of DQ signals/signal interfaces 112a1. Likewise, channel B DQ interface 112b may be divided (or includes) a corresponding (to channel A DQ interface 112a) first set of DQ signals/signal interfaces 112b0 and a second set of DQ signals/signal interfaces 112b1. In an embodiment, the first sets of DQ signals interfaces 112a0-112b0 and the second sets of DQ signal interfaces 112a1-112b1 each include equal numbers of signals as the other sets, and are also all disjoint sets.

As referenced herein, this first mode may also be known as “Dual xN channel mode” where, in reference to FIGS. 1A-1J, N corresponds the number of “native” data bits (e.g., 16-bits, 8-bits, 4-bits, etc.) used for data communication between controller 120a and memory device 110 via each of channel A DQ interface 112a, channel B DQ interface 112b, channel A DQ interface 122aa, and channel B DQ interface 122ab. Thus, in an embodiment, each of DQ signal interfaces 112a0-112a1 and 112b0-112b1 may use N “native” data signals/interfaces for data communication.

Channel A DQ interface 112a of memory device 110 is operatively coupled with channel A DQ interface 122aa of controller 120a respectively via DQ signal interfaces 112a0-112a1 and DQ signals 132a0-132a1. Channel B DQ interface 112b of memory device 110 is operatively coupled with channel B DQ interface 122ab of controller 120a respectively via DQ signal interfaces 112b0-112b1 and DQ signals 132b0-132b1. In FIG. 1A, memory device 110 is configured with memory arrays 114a operatively coupled with channel A DQ interface 112a, and first and second sets of DQ signal interfaces 112a0-112a1, in particular. Memory device 110 is also configured with memory arrays 114b operatively coupled with channel B DQ interface 112b, and first and second sets of DQ signal interfaces 112b0-112b1, in particular.

In the first mode, in an embodiment, each of memory arrays 114a-114b do not have any common memory arrays among them (i.e., are each nonoverlapping sets of memory arrays). Thus, in this first mode, in an embodiment, memory channel DQ interfaces 112a-112b are respective operatively coupled with memory arrays 114a-114b and operate independently of each other. In other words, each memory channel DQ interface 112a-112b, and operatively coupled memory arrays 114a-114b, each operate with the command, address, and data transfer functions of their respective memory channel interfaces to access respective memory arrays 114a-114b independently of the other memory channel DQ interface 112a-112b and other memory arrays 114a-114b. Thus, it should be understood that when memory device 110 is in this first mode, controller 120a may, independent of accesses to memory arrays 114b, access memory arrays 114a via channel A DQ interface 122aa, DQ signals 132a0-132a1, and sets of DQ signal interfaces 112a0-1112a1. Likewise, in this first mode, controller 120a may, independent of accesses to memory arrays 114a, access memory arrays 114b via channel B DQ interface 122ab, DQ signals 132b0-132b1, and sets of DQ signal interfaces 112b0-112b1.

FIG. 1B illustrates a second example, mode/configuration for a memory device. In FIG. 1B, memory system 100b comprises memory device 110 and controller 120b. In FIG. 1B, controller 120b includes channel A DQ interface 122ba, channel B DQ interface 122bb, and control circuitry 125b. Channel A DQ interface 112a of memory device 110 is operatively coupled with channel A DQ interface 122ba of controller 120b via first set of DQ signal interfaces 112a0 and DQ signals 132ba. Channel B DQ interface 112b of memory device 110 is operatively coupled with channel B DQ interface 122bb of controller 120b via first set of DQ signal interfaces 112b0 and DQ signals 132bb. The second set of DQ signal interfaces 112a1 of channel A DQ interface 112a is operatively coupled with DQ signals 133ba. The second set of DQ signal interfaces 112b1 of channel B DQ interface 112b is operatively coupled with DQ signals 133bb. In FIG. 1B, memory device 110 is configured with memory arrays 114a operatively coupled with channel A DQ interface 112a, and first set of DQ signal interfaces 112a0, in particular. Memory device 110 is also configured with memory arrays 114b operatively coupled with channel B DQ interface 112b, and first set of DQ signal interfaces 112b0, in particular.

As referenced herein, this second mode may also be known as “Dual channel, xN/2 lower-to-upper relay mode”. Thus, in an embodiment, each of channel A DQ interface 122ba channel B DQ interface 122bb, first set of DQ signal interfaces 112a0, and first set of DQ signal interfaces 112b0 may use N/2 data signals/interfaces for data communication between controller 120b and memory device 110, and memory device 110 may use N/2 signals/interfaces for communication via the second sets of DQ signal interfaces 121a1-121b1 for communication with another memory device. Another dual channel xN/2 relay mode (not illustrated in FIGS. 1A-1J) includes “Dual channel, xN/2, upper-to-lower relay mode” where second set of DQ signal interfaces 112a1, and second set of DQ signal interfaces 112b1 may use N/2 data signals/interfaces for data communication with a controller 120, and memory device 110 may use N/2 signals/interfaces for communication via the first sets of DQ signal interfaces 121a0-121b0 for communication with another memory device.

First set of DQ signal interfaces 112a0 of channel A DQ interface 112a is also operatively coupled with second set of DQ signal interfaces 112a1 of channel A DQ interface 112a. The first set of DQ signal interfaces 112a0 is operatively coupled with the second set of DQ signal interfaces 112a1 to communicate (e.g., relay) data between the first set of DQ signal interfaces 112a0 of channel A DQ interface 112a and the second set of DQ signal interfaces 112a1 of channel A DQ interface 112a. Thus, in this second mode, memory device 110 is configured to communicate (e.g., relay, or buffer) data between the first set of DQ signal interfaces 112a0 and the second set of DQ signal interfaces 112a1. Memory device 110 may be configured to communicate data between the first set of DQ signal interfaces 112a0 and the second set of DQ signal interfaces 112a1 in order to communicate data to/from controller 120b from/to another memory device (not shown in FIGS. 1A-1J) via DQ signals 133ba.

Similarly, first set of DQ signal interfaces 112b0 of channel B DQ interface 112b is also operatively coupled with second set of DQ signal interfaces 112b1 of channel B DQ interface 112b. The first set of DQ signal interfaces 112b0 is operatively coupled with second set of DQ signal interfaces 112b1 to communicate (e.g., relay) data between the first set of DQ signal interfaces 112b0 and the second set of DQ signal interfaces 112b1. Thus, in this second mode, memory device 110 is configured to communicate (e.g., relay, or buffer) data between the first set of DQ signal interfaces 112b0 and the second set of DQ signal interfaces 112b1. Memory device 110 may be configured to communicate data between the first set of DQ signal interfaces 112b0 and the second set of DQ signal interfaces 112b1 in order to communicate data to/from controller 120b from/to another memory device (not shown in FIGS. 1A-1J) via DQ signals 133bb. In an embodiment, the another memory device communicating data via DQ signals 133ab and the another memory device communicating data via DQ signals 133bb are the same device.

In the second mode, in an embodiment, each of memory arrays 114a-114b do not have any common memory arrays among them (i.e., are each nonoverlapping sets of memory arrays). Thus, in this second mode, in an embodiment, memory channel DQ interfaces 112a-112b are respective operatively coupled memory arrays 114a-114b and operate independently of each other. In other words, each memory channel DQ interface 112a-112b, and operatively coupled memory arrays 114a-114b, each operate with the command, address, and data transfer functions of their respective memory channel interfaces to access respective memory arrays 114a-114b independently of the other memory channel DQ interface 112a-112b and other memory arrays 114a-114b. Thus, it should be understood that when memory device 110 is in this second mode, controller 120b may, independent of accesses to memory arrays 114b, access memory arrays 114a via channel A DQ interface 122ba, DQ signals 132ba, and first set of DQ signal interfaces 112a0. Likewise, in this second mode, controller 120b may, independent of accesses to memory arrays 114a, access memory arrays 114b via channel B DQ interface 122bb, DQ signals 132bb, and first set of DQ signal interfaces 112b0. Also when memory device 110 is in this second mode, controller 120b may access a first channel (e.g., channel A) of a different memory device (e.g., one stacked with memory device 110) via channel A DQ interface 122ba, DQ signals 132ba, first set of DQ signal interfaces 112a0, second set of DQ signal interfaces 112a1, and DQ signals 133ba. Similarly, when memory device 110 is in this second mode, controller 120b may access a second channel (e.g., channel B) of the different memory device) via channel B DQ interface 122bb, DQ signals 132bb, first set of DQ signal interfaces 112b0, second set of DQ signal interfaces 112b1, and DQ signals 133bb.

FIG. 1C illustrates a second example, mode/configuration for a memory device. In FIG. 1C, memory system 100c comprises memory device 110 and controller 120c. In FIG. 1C, controller 120c includes channel A DQ interface 122ca, channel B DQ interface 122cb, and control circuitry 125c. Channel A DQ interface 112a of memory device 110 is operatively coupled with channel A DQ interface 122ca of controller 120c via second set of DQ signal interfaces 112a1 and DQ signals 133ca. Channel B DQ interface 112b of memory device 110 is operatively coupled with channel B DQ interface 122cb of controller 120c via second set of DQ signal interfaces 112b1 and DQ signals 133cb. In FIG. 1C, memory device 110 is configured with memory arrays 114a operatively coupled with channel A DQ interface 112a, and second set of DQ signal interfaces 112a1, in particular. Memory device 110 is also configured with memory arrays 114b operatively coupled with channel B DQ interface 112b, and second set of DQ signal interfaces 112b1, in particular.

As referenced herein, this third mode may also be known as “Dual channel, xN/2, upper endpoint mode”. Thus, in an embodiment, each of channel A DQ interface 122ca, channel B DQ interface 122cb, and the second sets of DQ interfaces 112a1-112b1 may use N/2 data signals/interfaces for data communication with controller 120c, and the first sets of DQ signal interfaces 112a0-112b0 are not communicating with another device. Other dual channel xN/2 endpoint modes (not illustrated in FIGS. 1A-1J) include “Dual channel, xN/2, lower endpoint mode” where the first sets of DQ interfaces 112a0-112b0 may use N/2 data signals/interfaces for data communication with a controller, and the second sets of DQ signal interfaces 112a1-112b1 are not communicating with another device; “Dual channel, xN/2, mixed Lower-Upper endpoint mode” where the first set of DQ signal interfaces 112a0 and the second set of DQ interfaces 112b1 may use N/2 data signals/interfaces for data communication with a controller, and the second set of DQ signal interfaces 112a1 and the first set of DQ signal interface 112b0 are not communicating with another device; and, “Dual channel, xN/2, mixed Upper-Lower endpoint mode” where the second set of DQ interfaces 112a1 and the first set of DQ interfaces 112b0 may use N/2 data signals/interfaces for data communication with a controller, and the first set of DQ signal interfaces 112a0 and the second set of DQ signal interface 112b1 are not communicating with another device.

First set of DQ signal interfaces 112a0 of channel A DQ interface 112a are, in this third mode, disabled. Similarly, first set of DQ signal interfaces 112b0 of channel B DQ interface 112b is also, in this third mode, disabled. In the third mode, in an embodiment, each of memory arrays 114a-114b do not have any common memory arrays among them (i.e., are each nonoverlapping sets of memory arrays). Thus, in this third mode, in an embodiment, memory channel DQ interfaces 112a-112b are respective operatively coupled with memory arrays 114a-114b and operate independently of each other. In other words, each memory channel DQ interface 112a-112b, and operatively coupled memory arrays 114a-114b, each operate with the command, address, and data transfer functions of their respective memory channel interfaces to access respective memory arrays 114a-114b independently of the other memory channel DQ interface 112a-112b and other memory arrays 114a-114b. Thus, it should be understood that when memory device 110 is in this third mode, controller 120c may, independent of accesses to memory arrays 114b, access memory arrays 114a via channel A DQ interface 122ca, DQ signals 133ca, and second set of DQ signal interfaces 112a1. Likewise, in this second mode, controller 120c may, independent of accesses to memory arrays 114a, access memory arrays 114b via channel B DQ interface 122cb, DQ signals 133cb, and second set of DQ signal interfaces 112b1.

FIG. 1D illustrates a fourth example, mode/configuration for a memory device. In FIG. 1D, memory system 100d comprises memory device 110 and controller 120d. In FIG. 1D, controller 120d includes channel DQ interface 122d, and control circuitry 125d. Channel A DQ interface 112a of memory device 110 is operatively coupled with channel DQ interface 122d of controller 120d respectively via DQ signal interfaces 112a0-112a1 and DQ signals 132d0-132d1. DQ signal interfaces 112b0-112b1 of channel B DQ interface 112b are respectively operatively coupled with DQ signals 133db0-133db1. In FIG. 1D, memory device 110 is configured with memory arrays 114a-114b operatively coupled with channel A DQ interface 112a, and both of sets of DQ signal interfaces 112a0-112a1, in particular.

As referenced herein, this fourth mode may also be known as “Single channel, xN channel A relay mode”. Thus, in an embodiment, each of channel DQ interface 122d and channel A DQ interface 112a may use N number of data signals/interfaces for data communication between controller 120d and memory device 110. Also, memory device 110 may also use N number of signals/interfaces for communication via the channel B DQ interface 112b for communication with another memory device. Another single channel xN relay mode (not illustrated in FIGS. 1A-1J) includes “Single channel, xN, channel B relay mode” channel B DQ interface 112b may use N number of data signals/interfaces for data communication with a controller, and memory device 110 may also use N number of signals/interfaces for communication via the channel A DQ interface 112a for communication with another memory device.

DQ signal interfaces 112a0-112a1 of channel A DQ interface 112a are also respectively operatively coupled with DQ signal interfaces 112b0-112b1 of channel B DQ interface 112b. DQ signal interfaces 112a0-112a1 are operatively coupled with DQ signal interfaces 112b0-112b1 to communicate (e.g., relay) data between DQ signal interfaces 112a0-112a1 of channel A DQ interface 112a and DQ signal interfaces 112b0-112b1 of channel B DQ interface 112b. Thus, in this fourth mode, memory device 110 is configured to communicate (e.g., relay, or buffer) data between DQ signal interfaces 112a0-112a1 of channel A DQ interface 112a and DQ signal interfaces 112b0-112b1 of channel B DQ interface 112b. Memory device 110 may be configured to communicate data between DQ signal interfaces 112a0-112a1 and the DQ signal interfaces 112b0-112b1 in order to communicate data to/from controller 120b from/to at least one other memory device (not shown in FIGS. 1A-1J) via DQ signals 133db0-133db1. In an embodiment, at least one of the at least one other memory device communicating data via DQ signals 133db0 and communicating data via DQ signals 133db1 are the same device.

From the foregoing it should be understood that, in the fourth mode, in an embodiment, each of memory arrays 114a-114b share channel A DQ interface 112a for data communication with controller 120d. Thus, it should be understood that when memory device 110 is in this fourth mode, controller 120b may not, independently of each other, access memory arrays 114a-114b.

FIG. 1E illustrates a fifth example, mode/configuration for a memory device. In FIG. 1E, memory system 100e comprises memory device 110 and controller 120e. In FIG. 1E, controller 120e includes channel DQ interface 122e, and control circuitry 125e. Channel B DQ interface 112b of memory device 110 is respectively operatively coupled with channel DQ interface 122e of controller 120e via DQ signal interfaces 112b0-112b1 and DQ signals 133e0-133e1. In FIG. 1E, memory device 110 is configured with memory arrays 114a-114b operatively coupled with channel B DQ interface 112b, and DQ signal interfaces 112b0-112b1, in particular. DQ signal interfaces 112a0-112a1 of channel A DQ interface 112a are, in this fifth mode, disabled.

As referenced herein, this fifth example mode may also be known as “Single channel, xN, B channel endpoint mode”. Thus, in an embodiment, each of channel DQ interface 122e and channel B DQ interface 112b may use N data signals/interfaces for data communication with controller 120e, with channel A DQ interface 112a not communicating with another device. Another single channel xN endpoint mode (not illustrated in FIGS. 1A-1J) includes “Single channel, xN, channel A endpoint mode” where channel A DQ interface 112a may use N data signals/interfaces for data communication with a controller, and channel B DQ interface 112b is not communicating with another device.

From the foregoing it should be understood that, in this fifth mode, in an embodiment, each of memory arrays 114a-114b share channel B DQ interface 112b for data communication with controller 120e. Thus, it should be understood that when memory device 110 is in this fifth mode, controller 120e may not, independently of each other, access memory arrays 114a-114b.

FIG. 1F illustrates a sixth example, mode/configuration for a memory device. In FIG. 1F, memory system 100f comprises memory device 110 and controller 120f. In FIG. 1F, controller 120f includes channel DQ interface 122f, and control circuitry 125f. Channel A DQ interface 112a of memory device 110 is operatively coupled with channel DQ interface 122f of controller 120d via first set of DQ signal interfaces 112a0 and DQ signals 132f. Second set of DQ signal interfaces 112a1 of channel A DQ interface is operatively coupled with DQ signals 133f. DQ signal interfaces 112b0-112b1 of channel B DQ interface 112b are disabled.

As referenced herein, this sixth mode may also be known as “Single channel, xN/2 channel A lower-to-upper relay mode”. Thus, in an embodiment, each of channel DQ interface 122f and first set of DQ signal interfaces 112a0 may use N/2 number of data signals/interfaces for data communication between controller 120f and memory device 110, and memory device 110 may also use N/2 number of signals/interfaces for communication via the second set of DQ signal interfaces 112a1 for data communication with another memory device. Other single channel xN/2 relay modes (not illustrated in FIGS. 1A-1J) include “Single channel, xN/2, channel A upper-to-lower relay mode” where second set of DQ signal interfaces 112a1 may use N/2 number of data signals/interfaces for data communication with a controller, and memory device 110 may also use N/2 number of signals/interfaces for communication via the first set of DQ signal interfaces 112a0 for data communication with another memory device; “Single channel, xN/2, channel A lower to channel B lower relay mode” where first set of DQ signal interfaces 112a0 may use N/2 number of data signals/interfaces for data communication with a controller, and memory device 110 may also use N/2 number of signals/interfaces for communication via the first set of DQ signal interfaces 112b0 for data communication with another memory device; “Single channel, xN/2, channel A upper to channel B lower relay mode” where second set of DQ signal interfaces 112a1 may use N/2 number of data signals/interfaces for data communication with a controller, and memory device 110 may also use N/2 number of signals/interfaces for communication via the first set of DQ signal interfaces 112b0 for data communication with another memory device; “Single channel, xN/2, channel A lower to channel B upper relay mode” where first set of DQ signal interfaces 112a0 may use N/2 number of data signals/interfaces for data communication with a controller, and memory device 110 may also use N/2 number of signals/interfaces for communication via the second set of DQ signal interfaces 112b1 for data communication with another memory device; and “Single channel, xN/2, channel A upper to channel B upper relay mode” where second set of DQ signal interfaces 112a1 may use N/2 number of data signals/interfaces for data communication with a controller, and memory device 110 may also use N/2 number of signals/interfaces for communication via the second set of DQ signal interfaces 112b1 for data communication with another memory device.

First set of DQ signal interfaces 112a0 of channel A DQ interface 112a is also operatively coupled with second set of DQ signal interfaces 112a1 of channel A DQ interface 112a. The first set of DQ signal interfaces 112a0 is operatively coupled with the second set of DQ signal interfaces 112a1 to communicate (e.g., relay) data between the first set of DQ signal interfaces 112a0 of channel A DQ interface 112a and the second set of DQ signal interfaces 112a1 of channel A DQ interface 112a. Thus, in this sixth mode, memory device 110 is configured to communicate (e.g., relay, or buffer) data between the first set of DQ signal interfaces 112a0 and the second set of DQ signal interfaces 112a1. Memory device 110 may be configured to communicate data between the first set of DQ signal interfaces 112a0 and the second set of DQ signal interfaces 112a1 in order to communicate data to/from controller 120b from/to another memory device (not shown in FIGS. 1A-1J) via DQ signals 133f.

From the foregoing it should be understood that, in the sixth mode, in an embodiment, each of memory arrays 114a-114b share channel A DQ interface 112a (and first set of DQ signal interfaces 112a0, in particular) for data communication with controller 120f. Thus, it should be understood that when memory device 110 is in this sixth mode, controller 120f may not, independently of each other, access memory arrays 114a-114b.

FIG. 1G illustrates a seventh example, mode/configuration for a memory device. In FIG. 1G, memory system 100g comprises memory device 110 and controller 120g. In FIG. 1G, controller 120g includes channel DQ interface 122g, and control circuitry 125g. Channel A DQ interface 112a of memory device 110 is operatively coupled with channel DQ interface 122g of controller 120g via second set of DQ signal interfaces 112a1 and DQ signals 133g. In FIG. 1G, memory device 110 is configured with memory arrays 114a-114b operatively coupled with channel A DQ interface 112a, and second set of DQ signal interfaces 112a1, in particular. First set of DQ signal interfaces 112a0 of channel A DQ interface 112a and DQ signal interfaces 112b0-112b1 of channel B DQ interface 112b are, in this seventh mode, disabled.

As referenced herein, this seventh example mode may also be known as “Single channel, xN/2, channel A upper endpoint mode”. Thus, in an embodiment, each of channel DQ interface 122g and second set of DQ signal interfaces 112a1 may use N/2 data signals/interfaces for data communication with controller 120g, with first set of DQ signal interfaces 112a0, and sets of DQ interfaces 112b0-112b1 not communicating with another device.

From the foregoing it should be understood that, in this seventh mode, in an embodiment, each of memory arrays 114a-114b share the second set of DQ signal interfaces 112a1 of channel A DQ interface 112a for data communication with controller 120g. Thus, it should be understood that when memory device 110 is in this seventh mode, controller 120g may not, independently of each other, access memory arrays 114a-114b.

FIG. 1H illustrates a eighth example, mode/configuration for a memory device. In FIG. 1H, memory system 100h comprises memory device 110 and controller 120h. In FIG. 1H, controller 120h includes channel DQ interface 122h, and control circuitry 125h. Channel A DQ interface 112a of memory device 110 is operatively coupled with channel DQ interface 122h of controller 120h via DQ signal interfaces 112a0 and DQ signals 132h. Second set of DQ signal interfaces 112a1 of channel A DQ interface 112a is operatively coupled with DQ signals 133ha1. First set of DQ signal interfaces 112b0 of channel B DQ interface 112b is operatively coupled with DQ signals 133hb0. Second set of DQ signal interfaces 112b1 of channel B DQ interface 112b is operatively coupled with DQ signals 133hb1.

As referenced herein, this eighth mode may also be known as one of a set of “Single channel, xN/2, channel A lower multi-relay mode”. Thus, in an embodiment, each of channel DQ interface 122h and first set of DQ signal interfaces 112a0 may use N/2 number of data signals/interfaces for data communication between controller 120h and memory device 110, and memory device 110 may also use N/2 number of signals/interfaces for communication via two or more of the second set of DQ signal interfaces 112a1 and the sets of DQ signal interfaces 112b0-112b1 for data communication with another memory device. Other multi-interface relay modes may include “Single channel, xN/2, channel A upper multi-relay mode”, “Single channel, xN/2, channel B lower multi-relay mode”, and “Single channel, xN/2, channel B upper multi-relay mode”—where each of these modes relays data between a controller via a one of the sets of DQ signal interfaces 112a1 112b0-112b1 and two or more of the remaining sets of DQ signal interfaces 112a0-112a1 112b0-112b1.

First set of DQ signal interfaces 112a0 of channel A DQ interface 112a is also operatively coupled with second set of DQ signal interfaces 112a1 of channel A DQ interface 112a, and DQ signal interfaces 112b0-112b1 of channel B DQ interface 112b. The first set of DQ signal interfaces 112a0 is operatively coupled with the second set of DQ signal interfaces 112a1 and DQ signal interfaces 112b0-112b1 to communicate (e.g., relay) data between the second set of DQ signal interfaces 112a1 of channel A DQ interface 112a, the DQ signal interfaces 112b0-112b1 of channel B DQ interface 112b, and the first set of DQ signal interfaces 112a0 of channel A DQ interface 112a. Thus, in this eighth mode, memory device 110 is configured to communicate (e.g., relay, or buffer) data between the first set of DQ signal interfaces 112a0 and one or more of the second set of DQ signal interfaces 112a1 and DQ signal interfaces 112b0-112b1. Memory device 110 may be configured to communicate data between the first set of DQ signal interfaces 112a0 and one or more of the second set of DQ signal interfaces 112a1 and DQ signal interfaces 112b0-112b1 in order to communicate data to/from controller 120b from/to one or more memory devices (not shown in FIGS. 1A-1J) via one or more of DQ signals 133ha1 and DQ signals 133hb0-133hb1.

From the foregoing it should be understood that, in the eighth mode, in an embodiment, each of memory arrays 114a-114b share channel A DQ interface 112a (and first set of DQ signal interfaces 112a0, in particular) for data communication with controller 120h. Thus, it should be understood that when memory device 110 is in this eighth mode, controller 120h may not, independently of each other, access memory arrays 114a-114b.

FIG. 1I illustrates a ninth example, mode/configuration for a memory device. In FIG. 1I, memory system 100i comprises memory device 110 and controller 120i. In FIG. 1I, controller 120i includes channel DQ interface 122i, and control circuitry 125i. Channel B DQ interface 112b of memory device 110 is operatively coupled with channel DQ interface 122i of controller 120i via first set of DQ signal interfaces 112b0 and DQ signals 133ib0. In FIG. 1I, memory device 110 is configured with memory arrays 114a-114b operatively coupled with channel B DQ interface 112b, and first set of DQ signal interfaces 112b0, in particular. DQ signal interfaces 112a0-112a1 of channel A DQ interface 112a and second set of DQ signal interfaces 112b1 of channel B DQ interface 112b are, in this ninth mode, disabled.

As referenced herein, this ninth example mode may also be known as “Single channel, xN/2, channel B lower endpoint mode”. Thus, in an embodiment, each of channel DQ interface 122i and first set of DQ signal interfaces 112b0 may use N/2 data signals/interfaces for data communication between controller 120i, with sets of DQ interfaces 112a0-112a1, and second set of DQ signal interfaces 112b1 not communicating with another device.

From the foregoing it should be understood that, in this ninth mode, in an embodiment, each of memory arrays 114a-114b share the first set of DQ signal interfaces 112b0 of channel B DQ interface 112b for data communication with controller 120i. Thus, it should be understood that when memory device 110 is in this ninth mode, controller 120i may not, independently of each other, access memory arrays 114a-114b.

FIG. 1J illustrates a tenth example, mode/configuration for a memory device. In FIG. 1J, memory system 100j comprises memory device 110 and controller 120j. In FIG. 1J, controller 120j includes channel DQ interface 122j, and control circuitry 125j. Channel B DQ interface 112b of memory device 110 is operatively coupled with channel DQ interface 122j of controller 120j via second set of DQ signal interfaces 112b1 and DQ signals 133jb1. In FIG. 1J, memory device 110 is configured with memory arrays 114a-114b operatively coupled with channel B DQ interface 112b, and second set of DQ signal interfaces 112b1, in particular. DQ signal interfaces 112a0-112a1 of channel A DQ interface 112a and first set of DQ signal interfaces 112b0 of channel B DQ interface 112b are, in this tenth mode, disabled.

As referenced herein, this tenth example mode may also be known as “Single channel, xN/2, channel B upper endpoint mode”. Thus, in an embodiment, each of channel DQ interface 122j and second set of DQ signal interfaces 112b1 may use N/2 data signals/interfaces for data communication between controller 120j, with sets of DQ interfaces 112a0-112a1, and first set of DQ signal interfaces 112b0 not communicating with another device.

From the foregoing it should be understood that, in this tenth mode, in an embodiment, each of memory arrays 114a-114b share the second set of DQ signal interfaces 112b1 of channel B DQ interface 112b for data communication with controller 120j. Thus, it should be understood that when memory device 110 is in this tenth mode, controller 120j may not, independently of each other, access memory arrays 114a-114b.

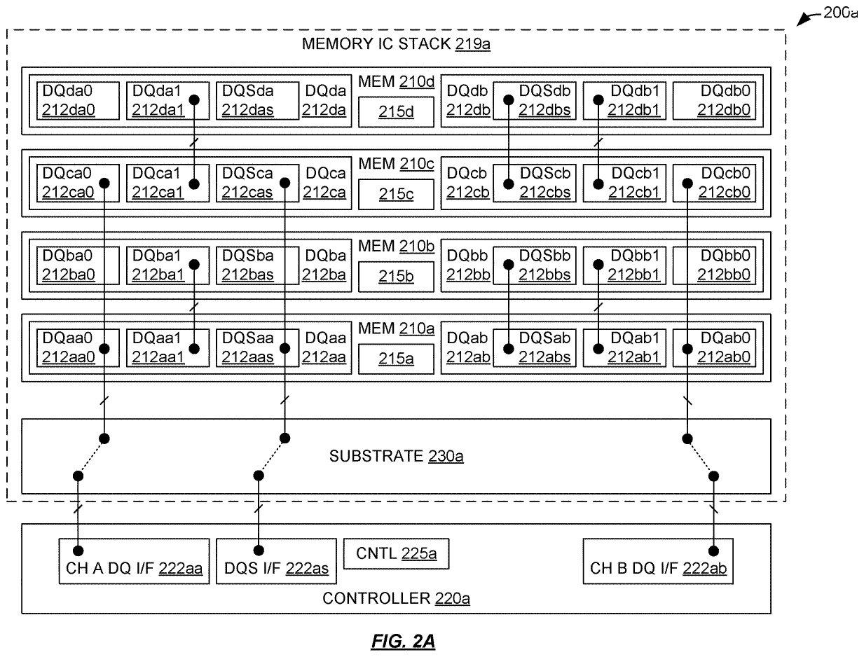

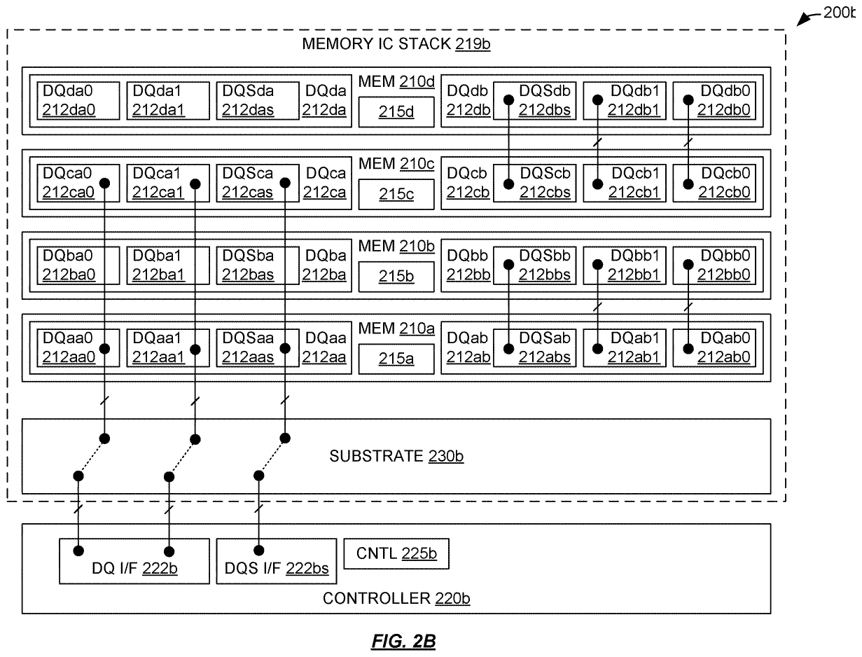

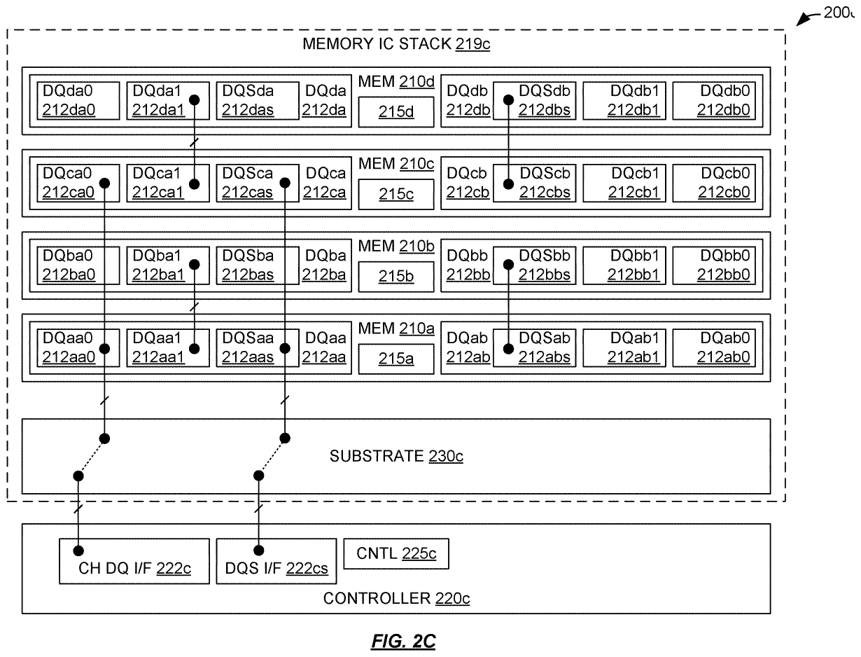

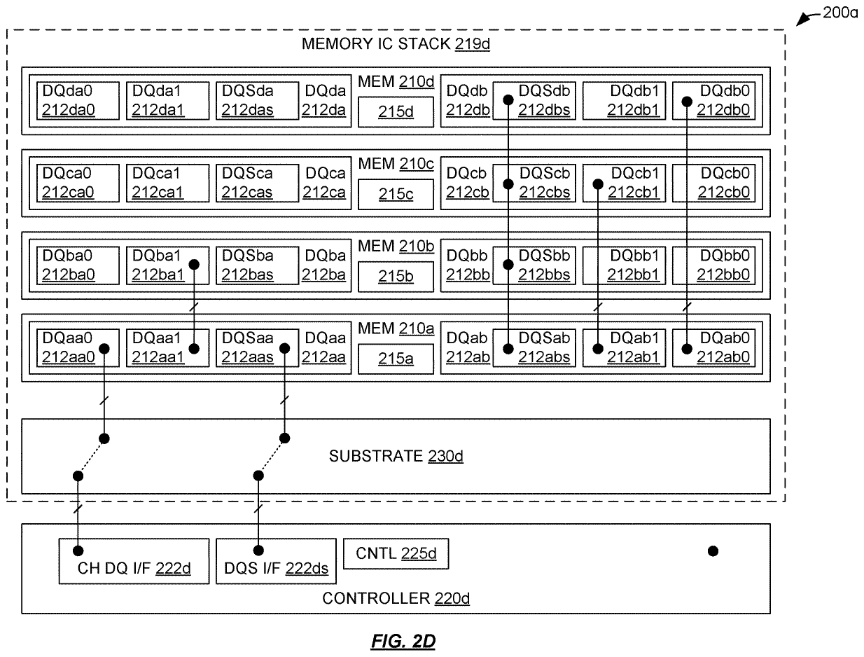

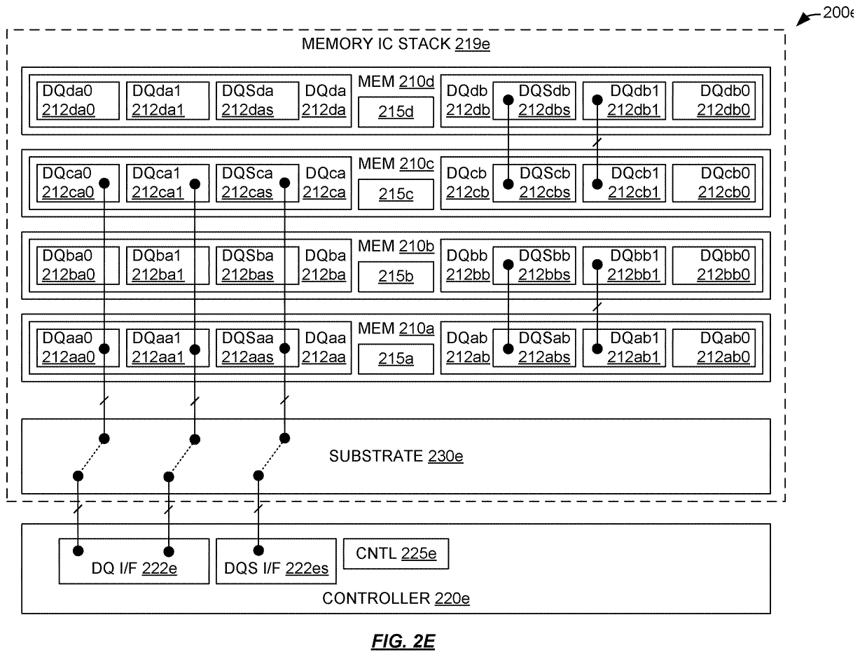

FIGS. 2A-2E are diagrams illustrating example stacked die data buffering. FIG. 2A illustrates a first example of stacked die data buffering. In FIG. 2A, memory system 200a comprises memory integrated circuit device (die) stack 219a and controller 220a. Memory integrated circuit device stack 219a may be a packaged memory component or other type of assembly with stacked memory integrated circuits that are interconnected (e.g., by wire bonds, and/or through-silicon vias—TSVs). Memory integrated circuit device stack 219a includes memory dies 210a-210d stacked with each other and with substrate 230a (e.g., on top of substrate 230a). Controller 220a includes channel A DQ interface 222aa, channel B DQ interface 222ab, data strobe (DQS) signal interface 222as, and control circuitry 225a.

Memory dies 210a-210d respectively include channel A DQ interfaces 212aa-212da (a.k.a., DQaa-DQda), channel B DQ interfaces 212ab-212db (a.k.a., DQab-DQdb), and control circuitry 215a-215d. Channel A DQ interfaces 212aa-212da respectively include first set of DQ signal interfaces 212aa0-212da0, second set of DQ signal interfaces 212aa1-212da1, and channel A DQS interfaces 212aas-212das. Channel B DQ interfaces 212ab-212db respectively include first set of DQ signal interfaces 212ab0-212db0, second set of DQ signal interfaces 212ab1-212db1, and channel B DQS interfaces 212abs-212dbs. It should also be understood that, in some embodiments, DQS interfaces 212aas-212das 212abs-212dbs may not be associated with a particular channel. Rather, a one of 212aas-212das 212abs-212dbs for each memory die 210a-210d may be shared by channel A and channel B and the other of 212aas-212das 212abs-212dbs for one or more memory die 210a-210d may be used for inter-die relay of a DQS signal.

Channel A DQ interface 222aa of controller 220a is operatively connected with first set of DQ signal interfaces 212aa0 of channel A DQ interface 212aa of memory device 210a and first set of DQ signal interfaces 212ca0 of channel A DQ interface 212ca of memory device 210c via substrate 230a. Channel A DQ interface 222aa of controller 220a may be operatively connected with first set of DQ signal interfaces 212aa0 of channel A DQ interface 212aa of memory device 210a and first set of DQ signal interfaces 212ca0 of channel A DQ interface 212ca of memory device 210c using substrate 230a to memory device 210a-210d interconnections (e.g., wire bonds between substrate 230a to one or more memory devices 210a-210d) and/or memory device 210a-210d to memory device 210a-210d interconnection (e.g., wire bonds between two or more memory devices 210a-210d).

Second set of DQ signal interfaces 212aa1 of channel A DQ interface 212aa of memory device 210a is operatively connected with second set of DQ signal interfaces 212ba1 of channel A DQ interface 212ba of memory device 210b. Second set of DQ signal interfaces 212aa1 of channel A DQ interface 212aa of memory device 210a may be operatively connected with second set of DQ signal interfaces 212ba1 of channel A DQ interface 212ba of memory device 210b using memory device 210a-210d to memory device 210a-210d interconnection (e.g., wire bonds between two or more memory devices 210a-210d). Second set of DQ signal interfaces 212aa1 of channel A DQ interface 212aa of memory device 210a is operatively connected with second set of DQ signal interfaces 212ba1 of channel A DQ interface 212ba of memory device 210b to communicate N/2 data signals, relayed by memory device 210a, from/to channel A DQ interface 222aa to/from the second set of DQ signal interfaces 212ba1 of channel A DQ interface 212ba of memory device 210b.

Second set of DQ signal interfaces 212ca1 of channel A DQ interface 212ca of memory device 210c is operatively connected with second set of DQ signal interfaces 212da1 of channel A DQ interface 212da of memory device 210d. Second set of DQ signal interfaces 212ca1 of channel A DQ interface 212ca of memory device 210c may be operatively connected with second set of DQ signal interfaces 212da1 of channel A DQ interface 212da of memory device 210d using memory device 210a-210d to memory device 210a-210d interconnection (e.g., wire bonds between two or more memory devices 210a-210d). Second set of DQ signal interfaces 212ca1 of channel A DQ interface 212ca of memory device 210c is operatively connected with second set of DQ signal interfaces 212da1 of channel A DQ interface 212da of memory device 210d to communicate N/2 data signals, relayed by memory device 210c, from/to channel A DQ interface 222aa to/from the second set of DQ signal interfaces 212da1 of channel A DQ interface 212da of memory device 210d.

DQS signal interface 222as of controller 220a is operatively connected with DQS signal interface 212aas of channel A DQ interface 212aa of memory device 210a and DQS signal interface 212cas of channel A DQ interface 212ca of memory device 210c via substrate 230a. DQS signal interface 222as of controller 220a may be operatively connected with DQS signal interface 212aas of channel A DQ interface 212aa of memory device 210a and DQS signal interface 212cas of channel A DQ interface 212ca of memory device 210c using substrate 230a to memory device 210a-210d interconnections (e.g., wire bonds between substrate 230a to one or more memory devices 210a-210d) and/or memory device 210a-210d to memory device 210a-210d interconnection (e.g., wire bonds between two or more memory devices 210a-210d).

DQS signal interface 212abs of channel B DQ interface 212ab of memory device 210a is operatively connected with DQS signal interface 212bbs of channel B DQ interface 212bb of memory device 210b. DQS signal interface 212abs of channel B DQ interface 212ab of memory device 210a may be operatively connected with DQS signal interface 212bbs of channel B DQ interface 212bb of memory device 210b using memory device 210a-210d to memory device 210a-210d interconnection (e.g., wire bonds between two or more memory devices 210a-210d). DQS signal interface 212abs of channel B DQ interface 212ab of memory device 210a is operatively connected with DQS signal interface 212bbs of channel B DQ interface 212bb of memory device 210b to communicate timing reference (e.g., data strobe) signals, relayed by memory device 210a, from/to DQS signal interface 222as to/from DQS signal interface 212bbs of channel B DQ interface 212bb of memory device 210b.

DQS signal interface 212cbs of channel B DQ interface 212cb of memory device 210c is operatively connected with DQS signal interface 212dbs of channel B DQ interface 212db of memory device 210d. DQS signal interface 212cbs of channel B DQ interface 212cb of memory device 210c may be operatively connected with DQS signal interface 212dbs of channel B DQ interface 212db of memory device 210d using memory device 210a-210d to memory device 210a-210d interconnection (e.g., wire bonds between two or more memory devices 210a-210d). DQS signal interface 212cbs of channel B DQ interface 212cb of memory device 210c is operatively connected with DQS signal interface 212dbs of channel B DQ interface 212db of memory device 210d to communicate timing reference (e.g., data strobe) signals, relayed by memory device 210c, from/to DQS signal interface 222as to/from DQS signal interface 212dbs of channel B DQ interface 212db of memory device 210d.

Channel B DQ interface 222ab of controller 220a is operatively connected with first set of DQ signal interfaces 212ab0 of channel B DQ interface 212ab of memory device 210a and first set of DQ signal interfaces 212cb0 of channel B DQ interface 212cb of memory device 210c via substrate 230a. Channel B DQ interface 222ab of controller 220a may be operatively connected with first set of DQ signal interfaces 212ab0 of channel A DQ interface 212ab of memory device 210a and first set of DQ signal interfaces 212cb0 of channel B DQ interface 212cb of memory device 210c using substrate 230a to memory device 210a-210d interconnections (e.g., wire bonds between substrate 230a to one or more memory devices 210a-210d) and/or memory device 210a-210d to memory device 210a-210d interconnection (e.g., wire bonds between two or more memory devices 210a-210d).

Second set of DQ signal interfaces 212ab1 of channel B DQ interface 212ab of memory device 210a is operatively connected with second set of DQ signal interfaces 212bb1 of channel B DQ interface 212bb of memory device 210b. Second set of DQ signal interfaces 212ab1 of channel B DQ interface 212ab of memory device 210a may be operatively connected with second set of DQ signal interfaces 212bb1 of channel B DQ interface 212bb of memory device 210b using memory device 210a-210d to memory device 210a-210d interconnection (e.g., wire bonds between two or more memory devices 210a-210d). Second set of DQ signal interfaces 212ab1 of channel B DQ interface 212ab of memory device 210a is operatively connected with second set of DQ signal interfaces 212bb1 of channel B DQ interface 212bb of memory device 210b to communicate N/2 data signals, relayed by memory device 210a, from/to channel B DQ interface 222ab to/from the second set of DQ signal interfaces 212bb1 of channel B DQ interface 212bb of memory device 210b.

Second set of DQ signal interfaces 212cb1 of channel B DQ interface 212cb of memory device 210c is operatively connected with second set of DQ signal interfaces 212db1 of channel B DQ interface 212db of memory device 210d. Second set of DQ signal interfaces 212cb1 of channel B DQ interface 212cb of memory device 210c may be operatively connected with second set of DQ signal interfaces 212db1 of channel B DQ interface 212db of memory device 210d using memory device 210a-210d to memory device 210a-210d interconnection (e.g., wire bonds between two or more memory devices 210a-210d). Second set of DQ signal interfaces 212cb1 of channel B DQ interface 212cb of memory device 210c is operatively connected with second set of DQ signal interfaces 212db1 of channel B DQ interface 212db of memory device 210d to communicate N/2 data signals, relayed by memory device 210c, from/to channel B DQ interface 222ab to/from the second set of DQ signal interfaces 212db1 of channel B DQ interface 212db of memory device 210d.

From the perspective of controller 220a, memory device stack 219a may appear as a dual xN/2 channel, four rank, component where each of controller 220a's DQ signals and DQS signals are connected to two memory devices (i.e., a signal load of two). It should also be noted that in this example, memory device 210a and memory device 210c may, for example, be configured in a “dual channel, xN/2 lower-to-upper relay mode”. Memory device 210b and memory device 210d may, for example, be configured in a “dual channel, xN/2, upper endpoint mode”.

In FIG. 2B, memory system 200b comprises memory integrated circuit device (die) stack 219b and controller 220b. Memory integrated circuit device stack 219b includes memory dies 210a-210d stacked with each other and with substrate 230b (e.g., on top of substate 230b). Controller 220b includes channel DQ interface 222b, data strobe (DQS) signal interface 222bs, and control circuitry 225b.

In FIG. 2B, channel DQ interface 222b of controller 220b is operatively connected to both sets of DQ signal interfaces 212aa0-212aa1 of memory device 210a and both sets of DQ signal interfaces 212ca0-212ca1 of memory device 210c. DQS signal interface 222bs is operatively connected to DQS signal interface 212aas of memory device 210a and DQS signal interface 212cas of memory device 210c. DQ signal interfaces 212ab0-212ab1 are respectively operatively connected to DQ signal interfaces 212bb0-212bb1. DQS signal interface 212abs is operatively connected to DQS signal interface 212bbs. DQ signal interfaces 212cb0-212cb1 are respectively operatively connected to DQ signal interfaces 212db0-212db1. DQS signal interface 212cbs is operatively connected to DQS signal interface 212dbs.

Memory device 210a is configured to relay DQ and DQS signals between channel A DQ interface 212aa and channel B DQ interface 212ab. Memory device 210b is configured to communicate DQ and DQS signals via channel B DQ interface 212bb. Memory device 210c is configured to relay DQ and DQS signals between channel A DQ interface 212ca and channel B DQ interface 212cb. Memory device 210d is configured to communicate DQ and DQS signals via channel B DQ interface 212db.

From the perspective of controller 220b, memory device stack 219b may appear as a single xN channel, four rank, component where each of controller 220b's DQ signals and DQS signals are connected to two memory devices (i.e., a signal load of two). It should also be noted that in this example, memory device 210a and memory device 210c may, for example, be configured in a “single channel, xN channel A relay mode”. Memory device 210b and memory device 210d may, for example, be configured in a “single channel, xN, B channel endpoint mode”.

In FIG. 2C, memory system 200c comprises memory integrated circuit device (die) stack 219c and controller 220c. Memory integrated circuit device stack 219c includes memory dies 210a-210d stacked with each other and with substrate 230c (e.g., on top of substate 230c). Controller 220c includes channel DQ interface 222c, data strobe (DQS) signal interface 222cs, and control circuitry 225c.

In FIG. 2C, channel DQ interface 222c of controller 220c is operatively connected to first set of DQ signal interfaces 212aa0 of memory device 210a and first set of DQ signal interfaces 212ca0 of memory device 210c. DQS signal interface 222cs is operatively connected to DQS signal interface 212aas of memory device 210a and DQS signal interface 212cas of memory device 210c. Second set of DQ signal interfaces 212aa1 is operatively connected to second set of DQ signal interfaces 212ba1. Second set of DQ signal interfaces 212ca1 is operatively connected to second set of DQ signal interfaces 212da1. DQS signal interface 212abs is operatively connected to DQS signal interface 212bbs. DQS signal interface 212cbs is operatively connected to DQS signal interface 212dbs.

Memory device 210a is configured to relay DQ signals between first set of DQ signal interfaces 212aa0 and second set of DQ signal interfaces 212aa1. Memory device 210a is configured to relay (and optionally retime) DQS signals between channel A DQS signal interface 212aas and channel B DQS signal interface 212abs. Memory device 210b is configured to communicate DQ signals via second set of DQ signal interfaces 212ba1. Memory device 210b is configured to communicate (e.g., transmit and/or receive) DQS signals via channel B DQS signal interface 212bbs. In an embodiment, the DQS signals communicated via DQS signal interfaces 212abs-212bbs are used to time die-to-die data transfers via DQ signal interface 212aa1 and DQ signal interface 212ba1.

Memory device 210c is configured to relay DQ signals between first set of DQ signal interfaces 212ca0 and second set of DQ signal interfaces 212ca1. Memory device 210c is configured to relay DQS signals from/to channel A DQS signal interface 212cas to/from channel B DQS signal interface 212cbs. Memory device 210d is configured to communicate DQ signals via second set of DQ signal interfaces 212da1. Memory device 210d is configured to communicate (e.g., transmit and/or receive) DQS signals via channel B DQS signal interface 212dbs. In an embodiment, the DQS signals communicated via DQS signal interfaces 212cbs-212dbs are used to time die-to-die data transfers via DQ signal interface 212ca1 and DQ signal interface 212da1.

From the perspective of controller 220c, memory device stack 219c may appear as a single xN/2 channel, four rank, component where each of controller 220c's DQ signals and DQS signals are connected to two memory devices (i.e., a signal load of two). It should also be noted that in this example, memory device 210a and memory device 210c may, for example, be configured in a “single channel, xN/2 channel A lower-to-upper relay mode”. Memory device 210b and memory device 210d may, for example, be configured in a “single channel, xN, B channel endpoint mode”.

In FIG. 2D, memory system 200d comprises memory integrated circuit device (die) stack 219d and controller 220d. Memory integrated circuit device stack 219d includes memory dies 210a-210d stacked with each other and with substrate 230d (e.g., on top of substate 230d). Controller 220d includes channel DQ interface 222d, data strobe (DQS) signal interface 222ds, and control circuitry 225d.

In FIG. 2D, channel DQ interface 222d of controller 220d is operatively connected to first set of channel A DQ signal interfaces 212aa0 of memory device 210a. DQS signal interface 222ds is operatively connected to Channel A DQS signal interface 212aas of memory device 210a. Second set of DQ signal interfaces 212aa1 is operatively connected to second set of DQ signal interfaces 212ba1 of memory device 210b. Channel B DQS signal interface 212abs is operatively connected to channel B DQS signal interface 212bbs of memory device 210b, channel B DQS signal interface 212cbs of memory device 210c, and channel B DQS signal interface 212dbs of memory device 210b. First set of DQ signal interfaces 212ab0 are operatively connected to first set DQ signal interfaces 212db0 of memory device 210d. Second set of DQ signal interfaces 212ab1 are operatively connected to second set of DQ signal interfaces 212cb1 of memory device 210c. Second set of DQ signal interfaces 212ca1 is operatively connected to second set of DQ signal interfaces 212da1.

Memory device 210a is configured to relay DQ signals to/from controller 220d communicated via DQ signal interfaces 212aa0: from/to DQ signal interfaces 212aa1 from/to memory device 210b; from/to DQ signal interfaces 212ab0 from/to memory device 210d; and from/to DQ signal interfaces 212ab1 from/to memory device 210c. Memory device 210a is configured to communicate DQS signals communicated (e.g., transmitted and/or received) via channel A DQS signal interface 212aas and channel B DQS signal interface 212abs with DQS interfaces 212bbs-212dbs. In an embodiment, the DQS signals communicated via channel B DQS signal interfaces 212abs, 212bbs, 212cbs, 212dbs are used to time die-to-die data transfers over the corresponding 212aa1/212ba1, 212ab1/212cb1, and 212ab0/212db0 interfaces.

From the perspective of controller 220d, memory device stack 219d may appear as a single xN/2 channel, four rank, component where each of controller 220d's DQ signals and DQS signals are connected to a single memory device (i.e., a signal load of one). It should also be noted that in this example, memory device 210a may, for example, be configured in a “single channel, xN/2, channel A lower multi-relay mode” (with DQS relay between channel A to channel B). Memory device 210b may, for example, be configured in a “single channel, xN/2, channel A upper endpoint mode” (with DQS coming communicated via channel B). Memory device 210c may, for example, be configured in a “single channel, xN/2, channel B upper endpoint mode” (with DQS coming communicated via channel B). Memory device 210d may, for example, be configured in a “single channel, xN/2, channel B lower endpoint mode” (with DQS coming communicated via channel B).

In FIG. 2E, memory system 200e comprises memory integrated circuit device (die) stack 219e and controller 220e. Memory integrated circuit device stack 219e includes memory dies 210a-210d stacked with each other and with substrate 230e (e.g., on top of substate 230e). Controller 220e includes channel DQ interface 222e, data strobe (DQS) signal interface 222es, and control circuitry 225e.

In FIG. 2E, channel DQ interface 222e of controller 220e is operatively connected to both sets of DQ signal interfaces 212aa0-212aa1 of memory device 210a and both sets of DQ signal interfaces 212ca0-212ca1 of memory device 210c. DQS signal interface 222es is operatively connected to DQS signal interface 212aas of memory device 210a and DQS signal interface 212cas of memory device 210c. Second set of DQ signal interfaces 212ab1 is operatively connected to second set of DQ signal interfaces 212bb1. DQS signal interface 212abs is operatively connected to DQS signal interface 212bbs. Second set of DQ signal interfaces 212cb1 is operatively connected to second set of DQ signal interfaces 212db1. DQS signal interface 212cbs is operatively connected to DQS signal interface 212dbs.

Memory device 210a is configured to relay DQ signals between second set of DQ signal interfaces 212aa1 and second set of DQ signal interfaces 212ab1. Memory device 210a is configured to bidirectionally relay DQS signals between channel A DQS signal interface 212aas and channel B DQS signal interface 212abs. Memory device 210b is configured to communicate DQ signals via second set of DQ signal interfaces 212bb1. Memory device 210b is configured to communicate DQS signals via channel B DQ signal interface 212bbs. Memory device 210c is configured to relay DQ signals between second set of DQ signal interfaces 212ca1 and second set of DQ signal interfaces 212cb1. Memory device 210c is configured to bidirectionally relay DQS signals between channel A DQS signal interface 212cas and channel B DQS signal interface 212cbs. Memory device 210d is configured to communicate DQ signals via second set of DQ signal interfaces 212db1. Memory device 210d is configured to communicate DQS signals via channel B DQS interface 212dbs.

From the perspective of controller 220e, memory device stack 219e may appear as a single xN channel, two rank, component where each of controller 220e's DQ signals and DQS signals are connected to two memory devices (i.e., a signal load of two). It should also be noted that in this example, memory device 210a may, for example, be configured in a “single channel, xN, channel A upper to channel B upper relay mode” (with DQS communicated between channel A and channel B). Memory device 210b may, for example, be configured in a “single channel, xN/2, channel B upper endpoint mode” (with DQS communicated via channel B). Memory device 210c may, for example, be configured in a “single channel, xN, channel A upper to channel B upper relay mode” (with DQS communicated between channel A and channel B). Memory device 210d may, for example, be configured in a “single channel, xN/2, channel B upper endpoint mode” (with DQS coming from channel B).

In FIGS. 2A-2E, certain DQ and DQS signals are illustrated as being relayed by one or more of memory die 210a-210d and/or driven by controllers 220a-220e to one or two other memory die 210a-210e. This helps reduce the number of DQS signals communicated with controller 220e (and stack 219e) when compared to other example configurations. However, it should be understood that these are example configurations. One or more DQ and DQS signals may, in some embodiments, be relayed to/from multiple (e.g., 2, 3, 4, etc.) other memory dies 210a-210e. These other configurations have not, for the sake of brevity, been illustrated in FIGS. 2A-2E.

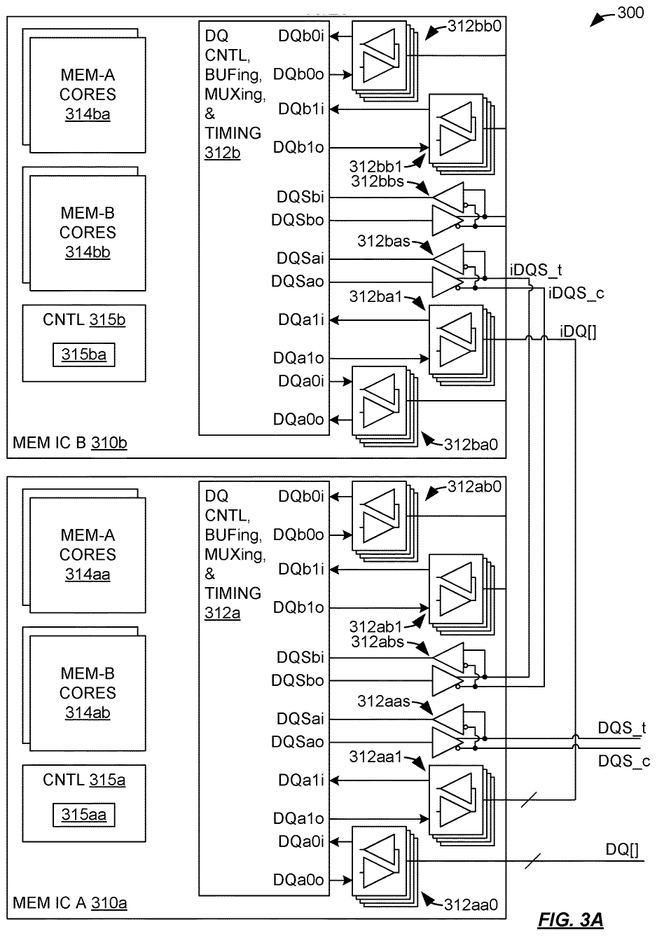

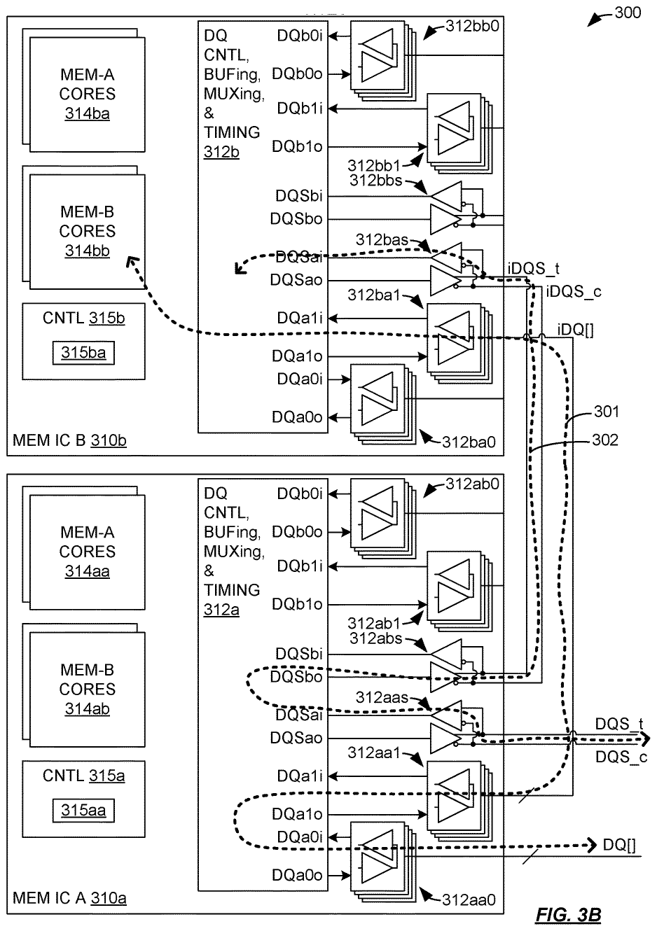

FIGS. 3A-3B are diagrams illustrating a first example data I/O buffering configuration. In FIGS. 3A-3B, memory device stack 300 comprises memory integrated circuit device 310a and memory integrated circuit device 310b. Memory integrated circuit device 310a and memory integrated circuit device 310b are, in an embodiment, stacked with each other. Memory integrated circuit device 310a includes channel A first set of DQ signal interfaces 312aa0, channel A second set of DQ signal interfaces 312aa1, channel B first set of DQ signal interfaces 312ab0, channel B second set of DQ signal interfaces 312ab1, channel A data strobe (DQS) signal interface 312aas, channel B DQS interface 312abs, DQ control, configuration, buffering, multiplexing, and timing (a.k.a., DQ config) circuitry 312a, channel A memory arrays 314aa, channel B memory arrays 314ab, and control circuitry 315a. Control circuitry 315a includes mode circuitry 315aa.

Memory integrated circuit device 310b includes channel A first set of DQ signal interfaces 312ba0, channel A second set of DQ signal interfaces 312ba1, channel B first set of DQ signal interfaces 312bb0, channel B second set of DQ signal interfaces 312bb1, channel A data strobe (DQS) interface 312bas, channel B DQS interface 312bbs, DQ control, configuration, buffering, multiplexing, and timing (a.k.a., DQ config) circuitry 312b, channel A memory arrays 314ba, channel B memory arrays 314bb, and control circuitry 315b. Control circuitry 315b includes mode circuitry 315ba.

In FIGS. 3A-3B, channel A first set of DQ signal interfaces 312aa0 is operatively coupled with external DQ signals DQ[ ] (e.g., to/from a controller) and DQ config circuitry 312a. Channel A second set of DQ signal interfaces 312aa1 is operatively coupled with DQ config circuitry 312a and internal, to the stack, DQ signals iDQ[ ]. Channel A DQS interface 312aas is operatively coupled with a differential external (e.g., to/from controller) DQS signal DQS_t DQS_c and DQ config circuitry 312a. Channel B DQS interface 312abs is operatively coupled with DQ config circuitry and internal, to the stack, DQS signal iDQS_t iDQS_c. Channel B first set of DQ signal interfaces 312ab0 is operatively coupled with DQ config circuitry 312a but is not connected externally to memory device 310a. Channel B second set of DQ signal interfaces 312ab1 is operatively coupled with DQ config circuitry 312a but is not connected externally to memory device 310a.

Channel A first set of DQ signal interfaces 312ba0 is operatively coupled with DQ config circuitry 312b, but is not connected externally to memory device 310b. Channel A second set of DQ signal interfaces 312ba1 is operatively coupled with DQ config circuitry 312b and stack internal DQ signals iDQ[ ]. Channel A DQS interface 312bas is operatively coupled with the stack internal DQS signal iDQS_t iDQS_c and DQ config circuitry 312b. Channel B DQS interface 312bbs is operatively coupled with DQ config circuitry 312b, but is not connected externally to memory device 310b. Channel B first set of DQ signal interfaces 312bb0 is operatively coupled with DQ config circuitry 312b but is not connected externally to memory device 310b. Channel B second set of DQ signal interfaces 312bb1 is operatively coupled with DQ config circuitry 312b but is not connected externally to memory device 310b.

Memory device 310a is configured (e.g., by control circuitry 315a and using DQ config circuitry 312a) to bidirectionally relay data accessed by memory device 310a. This is illustrated in FIG. 3B by bidirectional arrow 301 running, in order, from external DQ[ ] signals, through first set of DQ signal interfaces 312aa0, through DQ config circuitry 312a, through second set of DQ signal interfaces 312aa1, along stack internal DQ signals iDQ[ ], through second set of DQ signal interfaces 312ba1, through DQ config circuitry 312b, and terminating in memory channel B arrays 314b.

Memory device 310a is also configured (e.g., by control circuitry 315a and using DQ config circuitry 312a), for write operations, to unidirectionally relay the external DQS signal (DQS_t, DQS_c) received by memory device stack 300 to memory device 310b. For read operations, memory device 310a is to unidirectionally relay the DQS signal (DQS_t, DQS_c) received from memory device 310b to the external DQS signal. This is illustrated in FIG. 3B by bidirectional arrow 302 running, in order, from DQS signals DQS_t, DQS_c, through channel A DQS signal interface 312aas, through DQ config circuitry 312a, through channel B DQS signal interface, 312abs, along stack internal DQS signals iDQS_t, iDQS_c, through channel A DQSA interface 312bas, and terminating in DQ config circuitry 312b.

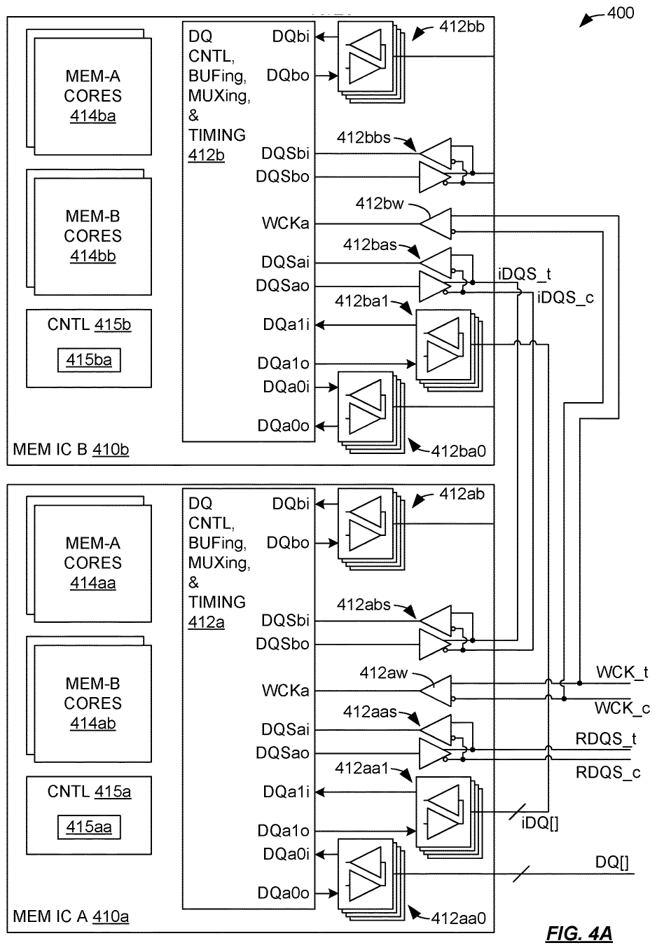

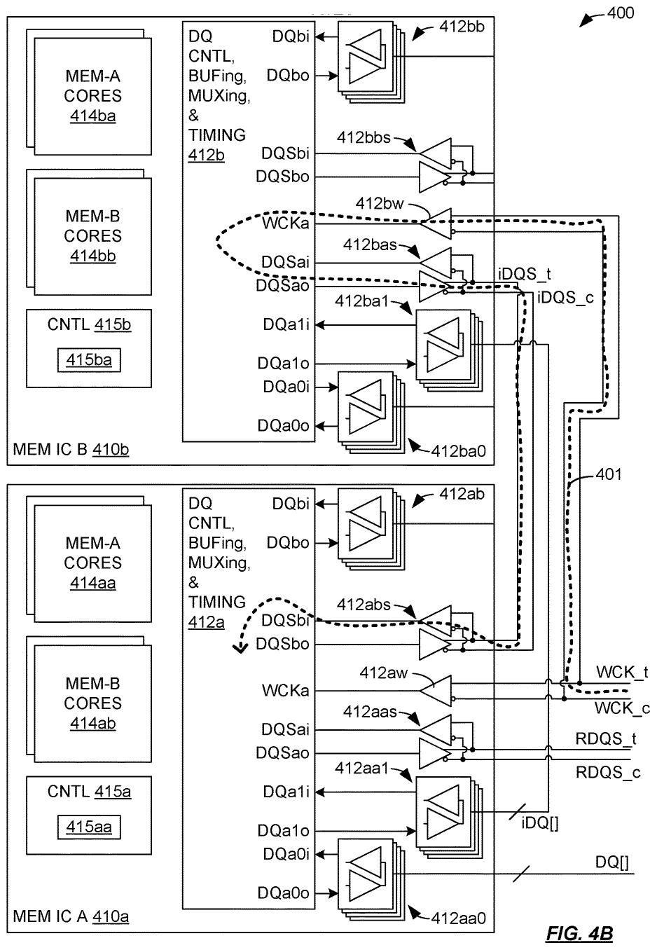

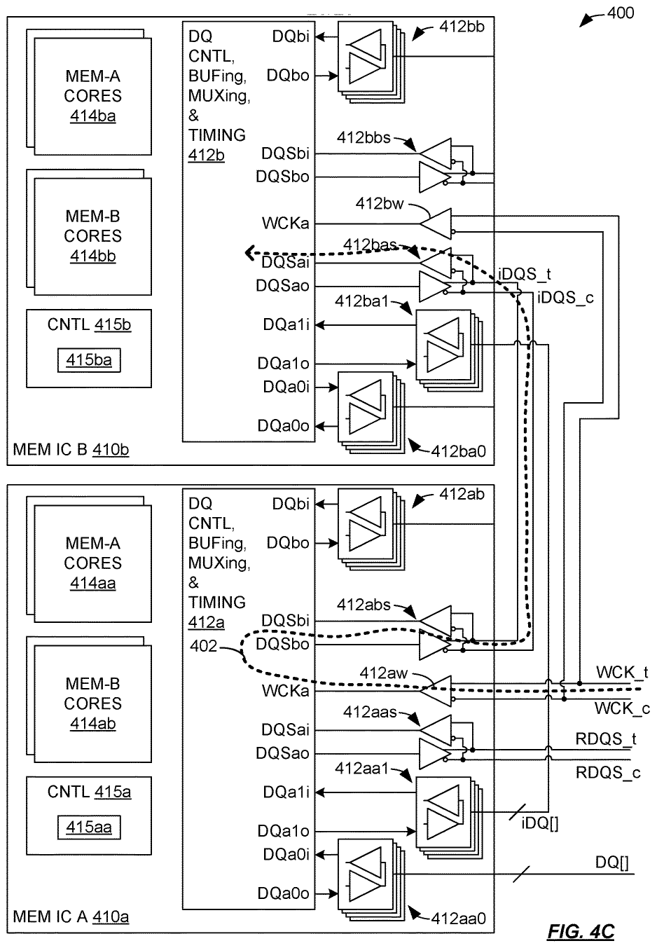

FIGS. 4A-4B are diagrams illustrating a second example data I/O buffering configuration. In FIGS. 4A-4B, memory device stack 400 comprises memory integrated circuit device 410a and memory integrated circuit device 410b. Memory integrated circuit device 410a and memory integrated circuit device 410b are, in an embodiment, stacked with each other. Memory integrated circuit device 410a includes channel A first set of DQ signal interfaces 412aa0, channel A second set of DQ signal interfaces 412aa1, channel B DQ signal interfaces 412ab, channel A data strobe (DQS) interface 412aas, channel B DQS interface 412abs, write clock interface 412aw, DQ control, configuration, buffering, multiplexing, and timing (a.k.a., DQ config) circuitry 412a, channel A memory arrays 414aa, channel B memory arrays 414ab, and control circuitry 415a. Control circuitry 415a includes mode circuitry 415aa.

Memory integrated circuit device 410b includes channel A first set of DQ signal interfaces 412ba0, channel A second set of DQ signal interfaces 412ba1, channel B DQ signal interfaces 412bb, channel A data strobe (DQS) interface 412bas, channel B DQS interface 412bbs, write clock interface 412bw, DQ control, configuration, buffering, multiplexing, and timing (a.k.a., DQ config) circuitry 412b, channel A memory arrays 414ba, channel B memory arrays 414bb, and control circuitry 415b. Control circuitry 415b includes mode circuitry 415ba.

In FIGS. 4A-4B, channel A first set of DQ signal interfaces 412aa0 is operatively coupled with external DQ signals DQ[ ] (e.g., to/from a controller) and DQ config circuitry 412a. Channel A second set of DQ signal interfaces 412aa1 is operatively coupled with DQ config circuitry 412a and internal, to the stack, DQ signals iDQ[ ]. Channel A DQS interface 412aas is operatively coupled with a differential external (e.g., to/from controller) RDQS signal RDQS_t RDQS_c and DQ config circuitry 412a. Write clock interface 412aw is operatively coupled with DQ config circuitry 412a and also receives an external, to the stack (e.g., to/from a controller) write clock signal WCK_t, WCK_c. Channel B DQS interface 412abs is operatively coupled with DQ config circuitry and internal, to the stack, DQS signal iDQS_t iDQS_c. Channel B DQ signal interfaces 412ab is operatively coupled with DQ config circuitry 412a, but is not connected externally to memory device 410a.

Channel A first set of DQ signal interfaces 412ba0 is operatively coupled with DQ config circuitry 412b but is not connected externally to memory device 410b. Channel A second set of DQ signal interfaces 412ba1 is operatively coupled with DQ config circuitry 412b and stack internal DQ signals iDQ[ ]. Channel A DQS interface 412bas is operatively coupled with the stack internal DQS signal iDQS_t iDQS_c and DQ config circuitry 412b. Write clock interface 412bw is operatively coupled with DQ config circuitry 412b and also receives an external, to the stack (e.g., to/from a controller) write clock signal WCK_t, WCK_c. Channel B DQS interface 412bbs is operatively coupled with DQ config circuitry 412b but is not connected externally to memory device 410b. Channel B DQ signal interfaces 412bb is operatively coupled with DQ config circuitry 412b but is not connected externally to memory device 410b.

Memory device 410a is configured (e.g., by control circuitry 415a and using DQ config circuitry 412a) to bidirectionally relay data accessed by memory device 410a. Memory device 410b is configured (e.g., by control circuitry 415b and using DQ config circuitry 412b), for read operations, to generate, from the write clock signal WCK_t, WCK_c a data strobe signal that may be used to communicate data between memory device 410a and 410b. In particular, memory device 410b generates stack internal DQS signals iDQS_t, iDQS_c which is derived from the write clock signal WCK_t, WCK_c when transferring data from memory device 410b to memory device 410a (e.g., to service a read operation targeted to the memory cores 414ba-414bb on memory device 410b). This is illustrated in FIG. 4B by unidirectional arrow 401 running, in order, from write clock signal WCK_t, WCK_c, through write clock interface 412bw, through DQ config circuitry 412b, through channel A DQS signal interface, 412bas, along stack internal DQS signals iDQS_t, iDQS_c, through channel B DQS interface 412abs, and terminating in DQ config circuitry 412a.

For write operations, memory device 410a is configured (e.g., by control circuitry 415a and using DQ config circuitry 412a), to generate, from the write clock signal WCK_t, WCK_c stack internal DQS signal iDQS_t iDQS_c that may be used to communicate data between memory device 410a and 410b. In particular, memory device 410a generates stack internal DQS signals iDQS_t, iDQS_c which is derived from the write clock signal WCK_t, WCK_c when transferring data from memory device 410a to memory device 410b (e.g., to service a write operation targeted to the memory cores 414ba-414bb on memory device 410b). This is illustrated in FIG. 4C by unidirectional arrow 402 running, in order, from write clock signal WCK_t, WCK_c, through write clock interface 412aw, through DQ config circuitry 412a, through channel A DQS signal interface, 412abs, along stack internal DQS signals iDQS_t, iDQS_c, through channel B DQS interface 412bass, and terminating in DQ config circuitry 412b.

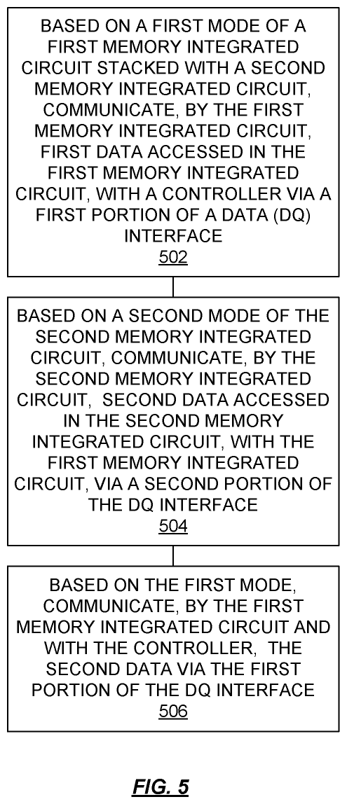

FIG. 5 is a flowchart illustrating a method of buffering data I/O signals. One or more steps illustrated in FIG. 5 may be performed by, for example, memory system 100, memory systems 100a-100j, memory systems 200a-200e, memory device stack 300, memory device stack 400, and/or their components. Based on a first mode of a first memory integrated circuit stacked with a second memory integrated circuit, first data accessed in the first memory integrated circuit is communicated, by the first memory integrated circuit, with a controller via a first portion of a data (DQ) interface (502). For example, memory device 210a may, based on being configured in a dual channel, xN/2 lower-to-upper relay mode or a single channel, xN/2 channel A lower-to-upper relay mode, communicate data accessed in memory device 210a via first set of DQ signal interfaces 212aa0. In another example, memory device 210a may, based on being configured in a single channel, xN/2 channel A lower-to-upper relay mode, communicate data accessed in memory device 210a via first set of DQ signal interfaces 212aa0.

Based on a second mode of the second memory integrated circuit, communicate, by the second memory integrated circuit, second data accessed in the second memory integrated circuit, with the first memory integrated circuit, via a second portion of the DQ interface (504). For example, memory device 210b, based on being configured in a dual channel, xN/2, upper endpoint mode or a single channel, xN/2, upper endpoint mode, communicate data accessed in memory device 210b with memory device 210a via second set of DQ signal interfaces 212ba1 and second set of DQ signal interfaces 212aa1. Based on the first mode and by the first memory integrated circuit, the second data is communicated via the first portion of the DQ interface (506). For example, memory device 210a may, based on being configured in a dual channel, xN/2 lower-to-upper relay mode or a single channel, xN/2 channel A lower-to-upper relay mode, communicate data to/from memory device 210b via first set of DQ signal interfaces 212aa0.

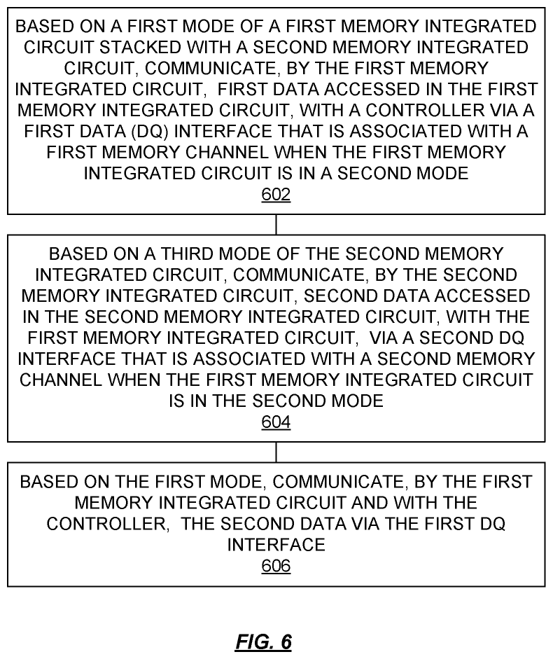

FIG. 6 is a flowchart illustrating a method of communicating data with a controller. One or more steps illustrated in FIG. 6 may be performed by, for example, memory system 100, memory systems 100a-100j, memory systems 200a-200e, memory device stack 300, memory device stack 400, and/or their components. Based on a first mode of a first memory integrated circuit stacked with a second memory integrated circuit and by the first memory integrated circuit, first data accessed in the first memory integrated circuit is communicated with a controller via a first data (DQ) interface that is associated with a first memory channel when the first memory integrated circuit is in a second mode (602). For example, based on being configured in a single channel, xN channel A relay mode, memory device 210a may communicate data accessed in memory device 210a with controller 220b via channel A DQ interface 212aa.

Based on a third mode of the second memory integrated circuit and by the second memory integrated circuit, second data accessed in the second memory integrated circuit is communicated with the first memory integrated circuit via a second DQ interface that is associated with a second memory channel when the first memory integrated circuit is in the second mode (604). For example, based on being in a single channel, xN, B channel endpoint mode, memory device 210b may communicate data accessed in memory device 210b with memory device 210a via channel B DQ interface 212bb and channel B DQ interface 212ab. Based on the first mode, by the first memory integrated circuit, and with the controller, the second data is communicated with the controller via the first DQ interface (606). For example, based on being configured in the single channel, xN channel A relay mode, memory device 210a may communicate, with controller 220b and via channel A DQ interface 212aa, the data accessed in memory device 210b (and communicated via channel B DQ interface 212bb and channel B DQ interface 212ab).

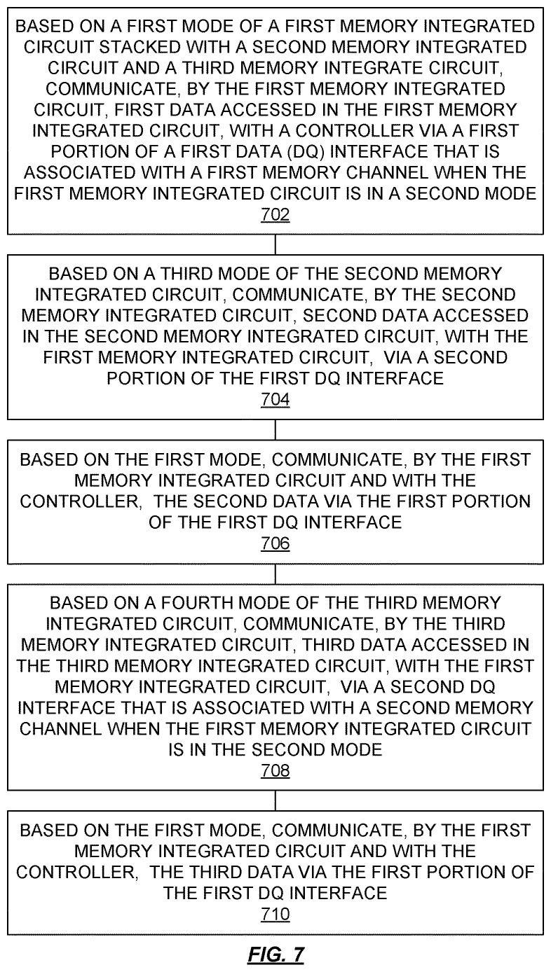

FIG. 7 is a flowchart illustrating a method of communicating data via a memory die stack. One or more steps illustrated in FIG. 7 may be performed by, for example, memory system 100, memory systems 100a-100j, memory systems 200a-200e, memory device stack 300, memory device stack 400, and/or their components. Based on a first mode of a first memory integrated circuit stacked with a second memory integrated circuit and a third memory integrated circuit and by the first memory integrated circuit, first data accessed in the first memory integrated circuit is communicated with a controller via a first portion of a first data (DQ) interface that is associated with a first memory channel when the first memory integrated circuit is in a second mode (702). For example, based on being configured in a single channel, xN/2, channel A lower multi-relay mode, memory device 210a may communicate data accessed in memory device 210a with controller 220d via first set of DQ signal interfaces 212aa0.

Based on a third mode of the second memory integrated circuit and by the second memory integrated circuit, second data accessed in the second memory integrated circuit is communicated with the first memory integrated circuit via a second portion of the first DQ interface (704). For example, based on being configured in a single channel, xN/2, channel A upper endpoint mode, memory device 210b may communicate data accessed in memory device 210b with memory device 210a via second set of DQ signal interfaces 212ba1 and second set of DQ signal interfaces 212aa1. Based on the first mode, by the first memory integrated circuit, and with the controller, the second data is communicated via the first portion of the first DQ interface (706). For example, based on being configured in the single channel, xN/2, channel A lower multi-relay mode, memory device 210a may communicate the data accessed in memory device 210b with controller 220d via the first set of DQ signal interfaces 212aa0 which was also communicated via the second set of DQ signal interfaces 212ba1 and the second set of DQ signal interfaces 212aa1.

Based on a fourth mode of the third memory integrated circuit and by the third memory integrated circuit, third data accessed in the third memory integrated circuit is communicated with the first memory integrated circuit via a second DQ interface that is associated with a second memory channel when the first memory integrated circuit is in the second mode (708). For example, based on being configured in a single channel, xN/2, channel B upper endpoint mode, memory device 210c may communicate data accessed in memory device 210c with memory device 210a via second set of DQ signal interfaces 212cb1 and second set of DQ signal interfaces 212ab1. Based on the first mode, by the first memory integrated circuit, and with the controller, the third data is communicated via the first portion of the first DQ interface (710). For example, based on being configured in the single channel, xN/2, channel A lower multi-relay mode, memory device 210a may communicate the data accessed in memory device 210c with controller 220d via the first set of DQ signal interfaces 212aa0 which was also communicated via the second set of DQ signal interfaces 212cb1 and the second set of DQ signal interfaces 212ab1.

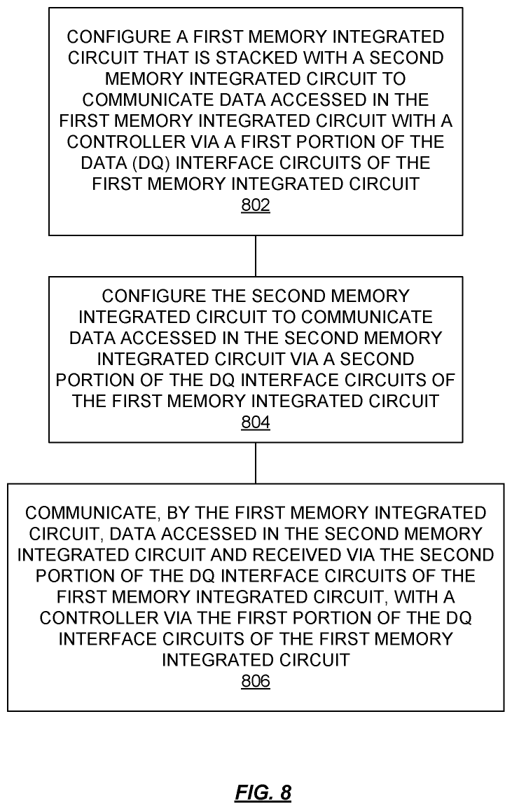

FIG. 8 is a flowchart illustrating a method of relaying data via a portion of a data I/O interface. One or more steps illustrated in FIG. 8 may be performed by, for example, memory system 100, memory systems 100a-100j, memory systems 200a-200e, memory device stack 300, memory device stack 400, and/or their components. A first memory integrated circuit that is stacked with a second memory integrated circuit is configured to communicate data accessed in the first memory integrated circuit with a controller via a first portion of the data (DQ) interface circuits of the first memory integrated circuit (802). For example, controller 220a may configure memory device 210a to communicate data accessed in memory device 210a via first set of DQ signal interfaces 212aa0.

The second memory integrated circuit is configured to communicate data accessed in the second memory integrated circuit via a second portion of the DQ interface circuits of the first memory integrated circuit (804). For example, controller 220a may configure memory device 210b to communicate data accessed in memory device 210b with memory device 210a via second set of DQ signal interfaces 212ba1 and second set of DQ signal interfaces 212aa1. By the first memory integrated circuit, data accessed in the second memory integrated circuit and received via the second portion of the DQ interface circuits of the first memory integrated circuit is communicated with a controller via the first portion of the DQ interface circuits of the first memory integrated circuit (806). For example, memory device 210a may communicate, with controller 220a and via first set of DQ signal interfaces 212aa0, data accessed in memory device 210b that was received via second set of DQ signal interfaces 212ba1 and second set of DQ signal interfaces 212aa1.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of memory systems 100a-100j, memory systems 200a-200e, memory device stack 300, and/or memory device stack 400, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3-½ inch floppy media, CDs, DVDs, and so on.

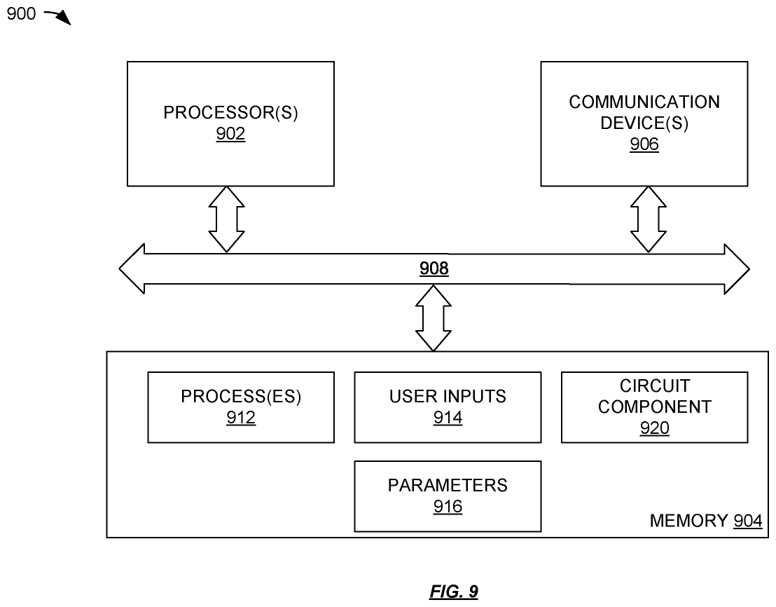

FIG. 9 is a block diagram illustrating one embodiment of a processing system 900 for including, processing, or generating, a representation of a circuit component 920. Processing system 900 includes one or more processors 902, a memory 904, and one or more communications devices 906. Processors 902, memory 904, and communications devices 906 communicate using any suitable type, number, and/or configuration of wired and/or wireless connections 908.

Processors 902 execute instructions of one or more processes 912 stored in a memory 904 to process and/or generate circuit component 920 responsive to user inputs 914 and parameters 916. Processes 912 may be any suitable electronic design automation (EDA) tool or portion thereof used to design, simulate, analyze, and/or verify electronic circuitry and/or generate photomasks for electronic circuitry. Representation 920 includes data that describes all or portions of memory systems 100a-100j, memory systems 200a-200e, memory device stack 300, and/or memory device stack 400, and their components, as shown in the Figures.

Representation 920 may include one or more of behavioral, register transfer, logic component, transistor, and layout geometry-level descriptions. Moreover, representation 920 may be stored on storage media or communicated by carrier waves.

Data formats in which representation 920 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 914 may comprise input parameters from a keyboard, mouse, voice recognition interface, microphone and speakers, graphical display, touch screen, or other type of user interface device. This user interface may be distributed among multiple interface devices. Parameters 916 may include specifications and/or characteristics that are input to help define representation 920. For example, parameters 916 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 904 includes any suitable type, number, and/or configuration of non-transitory computer-readable storage media that stores processes 912, user inputs 914, parameters 916, and circuit component 920.

Communications devices 906 include any suitable type, number, and/or configuration of wired and/or wireless devices that transmit information from processing system 900 to another processing or storage system (not shown) and/or receive information from another processing or storage system (not shown). For example, communications devices 906 may transmit circuit component 920 to another system. Communications devices 906 may receive processes 912, user inputs 914, parameters 916, and/or circuit component 920 and cause processes 912, user inputs 914, parameters 916, and/or circuit component 920 to be stored in memory 904.

Implementations discussed herein include, but are not limited to, the following examples:

Example 1: A memory device, comprising: a first set of memory arrays; a second set of memory arrays that does not overlap with the first set of memory arrays; a set of data input/output (I/O) circuits consisting of a first plurality of I/O circuits and a second plurality of I/O circuits, where the first plurality of I/O circuits and the second plurality of I/O circuits are disjoint sets of I/O circuits; the first plurality of I/O circuits to, based on a first mode, be configured to communicate data with a controller as part of a first memory access channel that accesses the first set of memory arrays; the second plurality of I/O circuits to, based on the first mode, be configured to communicate data with the controller as part of a second memory access channel that accesses the second set of memory arrays; a first subset of the set of data I/O circuits to, based on a second mode, communicate data with the controller to access the first set of memory arrays and the second set of memory arrays; and a second subset of the set of data I/O circuits to, based on the second mode, communicate data between the controller and another memory device stacked with the memory device for accesses of memory arrays of the another memory device, where first subset of the set of data I/O circuits and second subset of the set of data I/O circuits are disjoint sets of I/O circuits.

Example 2: The memory device of example 1, wherein, based on a third mode, a first portion of first subset of the set of data I/O circuits is to communicate data with the controller as part of a third memory access channel that accesses the first set of memory arrays, and a second portion of first subset of the set of data I/O circuits is to communicate data with the controller as part of a fourth memory access channel that accesses the second set of memory arrays, the first portion of first subset of the set of data I/O circuits and the second portion of first subset of the set of data I/O circuits to, in the third mode, be disjoint sets of I/O circuits.

Example 3: The memory device of example 1, wherein, based on a third mode, the first plurality of I/O circuits is to communicate data with the controller as part of a third memory access channel that accesses the first set of memory arrays and the second set of memory arrays, and the second plurality of I/O circuits is to communicate data with the another memory device.

Example 4: The memory device of example 1, wherein, based on a third mode, a first portion of the first plurality of I/O circuits is to communicate data with the controller as part of a third memory access channel that accesses the first set of memory arrays and the second set of memory arrays, and a second portion of first plurality of I/O circuits is to communicate data with the another memory device, the first portion of the first plurality of I/O circuits and second portion of first plurality of I/O circuits to, in the third mode, be disjoint sets of I/O circuits.

Example 5: The memory device of example 2, wherein the memory arrays of the another memory device comprise a third set of memory arrays and a fourth set of memory arrays that are disjoint sets of memory arrays, and, based on the third mode, a first portion of the second subset of set of data I/O circuits is to be used for accesses of the third set of memory arrays as part of the third memory access channel and a second portion of the second subset of set of data I/O circuits is to be used for accesses of the fourth set of memory arrays as part of the fourth memory access channel.

Example 6: The memory device of example 3, wherein the memory arrays of the another memory device comprise a third set of memory arrays and a fourth set of memory arrays that are disjoint sets of memory arrays, and, based on the third mode, the second plurality of I/O circuits is to be used for accesses of the third set of memory arrays and the fourth set of memory arrays as part of the third memory access channel.

Example 7: The memory device of example 4, wherein the memory arrays of the another memory device comprise a third set of memory arrays and a fourth set of memory arrays that are disjoint sets of memory arrays, and, based on the third mode, the second portion of the first plurality of I/O circuits is to communicate data with the another memory device for accesses of the third set of memory arrays and the fourth set of memory arrays as part of the third memory access channel.

Example 8: A memory component, comprising: a first memory integrated circuit die comprising: a first set of memory arrays and a second set of memory arrays, the first set of memory arrays and the second set of memory arrays being disjoint sets of memory arrays; and a first set of data input/output (I/O) circuits consisting of a first plurality of I/O circuits and a second plurality of I/O circuits, where the first plurality of I/O circuits and the second plurality of I/O circuits are disjoint sets of I/O circuits; a second memory integrated circuit die electrically coupled with, and stacked with, the first memory integrated circuit die, the second memory integrated circuit die comprising: a third set of memory arrays and a fourth set of memory arrays, the third set of memory arrays and the fourth set of memory arrays being disjoint sets of memory arrays; and a second set of data I/O circuits consisting of a third plurality of I/O circuits and a fourth plurality of I/O circuits, where the third plurality of I/O circuits and the fourth plurality of I/O circuits are disjoint sets of I/O circuits; the first memory integrated circuit die having a first mode where the first plurality of I/O circuits are used to access the first set of memory arrays and the second plurality of I/O circuits are used to access the second set of memory arrays; the first memory integrated circuit to, based on a second mode, use a first subset of the first set of data I/O circuits to access the first set of memory arrays and the second set of memory arrays; and the first memory integrated circuit to also, based on the second mode, use a second subset of the first set of data I/O circuits to, communicate data with the second memory integrated circuit die for accesses of the third set of memory arrays and the fourth set of memory arrays, the first subset of the first set of data I/O circuits and the second subset of the first set of data I/O circuits to, in the second mode, be disjoint sets of data I/O circuits.

Example 9: The memory component of example 8, wherein the second subset of the first set of data I/O circuits is coupled with the third plurality of I/O circuits.

Example 10: The memory component of example 9, wherein the first memory integrated circuit is to, based on a third mode, use a first portion of the second subset of the first set of data I/O circuits for accesses of the third set of memory arrays and use a second portion of the second subset of the first set of data I/O circuits for accesses of the fourth set of memory arrays, the first portion of the second subset of the first set of data I/O circuits and the second portion of the second subset of the first set of data I/O circuits to be, in the third mode, disjoint sets of data I/O circuits.

Example 11: The memory component of example 9, wherein: the first memory integrated circuit further comprises a first set of timing reference signal input circuits; and the second memory integrated circuit further comprises a second set of timing reference signal input circuits coupled with the first set of timing reference signal input circuits.

Example 12: The memory component of example 11, wherein: the first memory integrated circuit further comprises a first set of timing reference signal output circuits; and the second memory integrated circuit further comprises a second set of timing reference signal output circuits coupled with the first set of timing reference signal output circuits.

Example 13: The memory component of example 12, wherein respective ones of the first set of timing reference signal input circuit are coupled with respective ones of the first set of timing reference output circuits by the first memory integrated circuit, and respective ones of the second set of timing reference signal input circuit are coupled with respective ones of the second set of timing reference output circuits by the second memory integrated circuit.

Example 14: The memory component of example 8, wherein a controller is to use a first portion of the first subset of the first set of data I/O circuits for accesses of the first set of memory arrays as part of a first memory access channel and the controller is to use a second portion of the first subset of the first set of data I/O circuits for accesses of the second set of memory arrays as part of a second memory access channel.

Example 15: The memory component of example 14, wherein the controller is to use the first portion of the first subset of the first set of data I/O circuits and a first portion of the second subset of the first set of data I/O circuits for accesses of the third set of memory arrays as part of the first memory access channel via a first portion of the third plurality of I/O circuits and the controller is to use a second portion of the first subset of the first set of data I/O circuits and a second portion of the second subset of the first set of data I/O circuits for accesses of the fourth set of memory arrays as part of the second memory access channel via for accesses of the second set of memory arrays via a second portion of the third plurality of I/O circuits, a first portion of the third plurality of I/O circuits and second portion of the third plurality of I/O circuits being disjoint sets of data I/O circuits.

Example 16: A memory component, comprising: a first memory integrated circuit die having a first set of memory arrays and a second set of memory arrays, the first set of memory arrays and the second set of memory arrays being disjoint sets of memory arrays; a second memory integrated circuit die electrically coupled with, and stacked with, the first memory integrated circuit die, and having a third set of memory arrays and a fourth set of memory arrays, the third set of memory arrays and the fourth set of memory arrays being disjoint sets of memory arrays; the first memory integrated circuit die having a first mode where a first plurality of data I/O circuits are used to access the first set of memory arrays and a second plurality of data I/O circuits are used to access the second set of memory arrays; the first plurality of data I/O circuits to be configured, based on a second mode of the first memory integrated circuit, into a set of host data I/O circuit and a set of relay data I/O circuits, the set of host data I/O circuits and the set of relay data I/O circuits being disjoint sets of data I/O circuits; and the first memory integrated circuit to, based on the second mode, relay data between the set of host data I/O circuits and the set of relay data I/O circuits for accesses, by a controller, of the third set of memory arrays and the fourth set of memory arrays.

Example 17: The memory component of example 16, wherein accesses of a first rank by the controller access at least the first set of memory arrays and accesses of a second rank by the controller access at least the third set of memory arrays.

Example 18: The memory component of example 16, wherein the second memory integrated circuit is to, based on a third mode, use a third plurality of data I/O circuits to access the third set of memory arrays and a fourth plurality of data I/O circuits to access the fourth set of memory arrays, where the third plurality of data I/O circuits and the fourth plurality of data I/O circuits are disjoint sets of data I/O circuits.

Example 19: The memory component of example 18, wherein the third plurality of data I/O circuits is coupled with a first portion of the set of relay data I/O circuits and the second plurality of data I/O circuits is coupled with a second portion of the set of relay data I/O circuits, the first portion of the set of relay data I/O circuits and the second portion of the set of relay data I/O circuits being disjoint set of data I/O circuits.

Example 20: The memory component of example 19, wherein the controller is to access the first set of memory arrays and the third set of memory arrays via a first memory access channel and is to access the second set of memory arrays and the fourth set of memory arrays via a second memory access channel.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A memory device, comprising:
a first set of memory arrays;
a second set of memory arrays that does not overlap with the first set of memory arrays;
a set of data input/output (I/O) circuits consisting of a first plurality of I/O circuits and a second plurality of I/O circuits, where the first plurality of I/O circuits and the second plurality of I/O circuits are disjoint sets of I/O circuits;
the first plurality of I/O circuits to, based on a first mode, be configured to communicate data with a controller as part of a first memory access channel that accesses the first set of memory arrays;
the second plurality of I/O circuits to, based on the first mode, be configured to communicate data with the controller as part of a second memory access channel that accesses the second set of memory arrays;
a first subset of the set of data I/O circuits to, based on a second mode, communicate data with the controller to access the first set of memory arrays and the second set of memory arrays; and
a second subset of the set of data I/O circuits to, based on the second mode, communicate data between the controller and another memory device stacked with the memory device for accesses of memory arrays of the another memory device, where first subset of the set of data I/O circuits and second subset of the set of data I/O circuits are disjoint sets of I/O circuits.

2. The memory device of claim 1, wherein, based on a third mode, a first portion of first subset of the set of data I/O circuits is to communicate data with the controller as part of a third memory access channel that accesses the first set of memory arrays, and a second portion of first subset of the set of data I/O circuits is to communicate data with the controller as part of a fourth memory access channel that accesses the second set of memory arrays, the first portion of first subset of the set of data I/O circuits and the second portion of first subset of the set of data I/O circuits to, in the third mode, be disjoint sets of I/O circuits.

3. The memory device of claim 1, wherein, based on a third mode, the first plurality of I/O circuits is to communicate data with the controller as part of a third memory access channel that accesses the first set of memory arrays and the second set of memory arrays, and the second plurality of I/O circuits is to communicate data with the another memory device.

4. The memory device of claim 1, wherein, based on a third mode, a first portion of the first plurality of I/O circuits is to communicate data with the controller as part of a third memory access channel that accesses the first set of memory arrays and the second set of memory arrays, and a second portion of first plurality of I/O circuits is to communicate data with the another memory device, the first portion of the first plurality of I/O circuits and second portion of first plurality of I/O circuits to, in the third mode, be disjoint sets of I/O circuits.

5. The memory device of claim 2, wherein the memory arrays of the another memory device comprise a third set of memory arrays and a fourth set of memory arrays that are disjoint sets of memory arrays, and, based on the third mode, a first portion of the second subset of set of data I/O circuits is to be used for accesses of the third set of memory arrays as part of the third memory access channel and a second portion of the second subset of set of data I/O circuits is to be used for accesses of the fourth set of memory arrays as part of the fourth memory access channel.

6. The memory device of claim 3, wherein the memory arrays of the another memory device comprise a third set of memory arrays and a fourth set of memory arrays that are disjoint sets of memory arrays, and, based on the third mode, the second plurality of I/O circuits is to be used for accesses of the third set of memory arrays and the fourth set of memory arrays as part of the third memory access channel.

7. The memory device of claim 4, wherein the memory arrays of the another memory device comprise a third set of memory arrays and a fourth set of memory arrays that are disjoint sets of memory arrays, and, based on the third mode, the second portion of the first plurality of I/O circuits is to communicate data with the another memory device for accesses of the third set of memory arrays and the fourth set of memory arrays as part of the third memory access channel.

8. A memory component, comprising:
a first memory integrated circuit die comprising:
a first set of memory arrays and a second set of memory arrays, the first set of memory arrays and the second set of memory arrays being disjoint sets of memory arrays; and
a first set of data input/output (I/O) circuits consisting of a first plurality of I/O circuits and a second plurality of I/O circuits, where the first plurality of I/O circuits and the second plurality of I/O circuits are disjoint sets of I/O circuits;
a second memory integrated circuit die electrically coupled with, and stacked with, the first memory integrated circuit die, the second memory integrated circuit die comprising:
a third set of memory arrays and a fourth set of memory arrays, the third set of memory arrays and the fourth set of memory arrays being disjoint sets of memory arrays; and
a second set of data I/O circuits consisting of a third plurality of I/O circuits and a fourth plurality of I/O circuits, where the third plurality of I/O circuits and the fourth plurality of I/O circuits are disjoint sets of I/O circuits;
the first memory integrated circuit die having a first mode where the first plurality of I/O circuits are used to access the first set of memory arrays and the second plurality of I/O circuits are used to access the second set of memory arrays;
the first memory integrated circuit to, based on a second mode, use a first subset of the first set of data I/O circuits to access the first set of memory arrays and the second set of memory arrays; and
the first memory integrated circuit to also, based on the second mode, use a second subset of the first set of data I/O circuits to, communicate data with the second memory integrated circuit die for accesses of the third set of memory arrays and the fourth set of memory arrays, the first subset of the first set of data I/O circuits and the second subset of the first set of data I/O circuits to, in the second mode, be disjoint sets of data I/O circuits.

9. The memory component of claim 8, wherein the second subset of the first set of data I/O circuits is coupled with the third plurality of I/O circuits.

10. The memory component of claim 9, wherein the first memory integrated circuit is to, based on a third mode, use a first portion of the second subset of the first set of data I/O circuits for accesses of the third set of memory arrays and use a second portion of the second subset of the first set of data I/O circuits for accesses of the fourth set of memory arrays, the first portion of the second subset of the first set of data I/O circuits and the second portion of the second subset of the first set of data I/O circuits to be, in the third mode, disjoint sets of data I/O circuits.

11. The memory component of claim 9, wherein:
the first memory integrated circuit further comprises a first set of timing reference signal input circuits; and
the second memory integrated circuit further comprises a second set of timing reference signal input circuits coupled with the first set of timing reference signal input circuits.

12. The memory component of claim 11, wherein:
the first memory integrated circuit further comprises a first set of timing reference signal output circuits; and
the second memory integrated circuit further comprises a second set of timing reference signal output circuits coupled with the first set of timing reference signal output circuits.

13. The memory component of claim 12, wherein respective ones of the first set of timing reference signal input circuit are coupled with respective ones of the first set of timing reference output circuits by the first memory integrated circuit, and respective ones of the second set of timing reference signal input circuit are coupled with respective ones of the second set of timing reference output circuits by the second memory integrated circuit.

14. The memory component of claim 8, wherein a controller is to use a first portion of the first subset of the first set of data I/O circuits for accesses of the first set of memory arrays as part of a first memory access channel and the controller is to use a second portion of the first subset of the first set of data I/O circuits for accesses of the second set of memory arrays as part of a second memory access channel.

15. The memory component of claim 14, wherein the controller is to use the first portion of the first subset of the first set of data I/O circuits and a first portion of the second subset of the first set of data I/O circuits for accesses of the third set of memory arrays as part of the first memory access channel via a first portion of the third plurality of I/O circuits and the controller is to use a second portion of the first subset of the first set of data I/O circuits and a second portion of the second subset of the first set of data I/O circuits for accesses of the fourth set of memory arrays as part of the second memory access channel via for accesses of the second set of memory arrays via a second portion of the third plurality of I/O circuits, a first portion of the third plurality of I/O circuits and second portion of the third plurality of I/O circuits being disjoint sets of data I/O circuits.

16. A memory component, comprising:
a first memory integrated circuit die having a first set of memory arrays and a second set of memory arrays, the first set of memory arrays and the second set of memory arrays being disjoint sets of memory arrays;
a second memory integrated circuit die electrically coupled with, and stacked with, the first memory integrated circuit die, and having a third set of memory arrays and a fourth set of memory arrays, the third set of memory arrays and the fourth set of memory arrays being disjoint sets of memory arrays;
the first memory integrated circuit die having a first mode where a first plurality of data I/O circuits are used to access the first set of memory arrays and a second plurality of data I/O circuits are used to access the second set of memory arrays;
the first plurality of data I/O circuits to be configured, based on a second mode of the first memory integrated circuit, into a set of host data I/O circuit and a set of relay data I/O circuits, the set of host data I/O circuits and the set of relay data I/O circuits being disjoint sets of data I/O circuits; and
the first memory integrated circuit to, based on the second mode, relay data between the set of host data I/O circuits and the set of relay data I/O circuits for accesses, by a controller, of the third set of memory arrays and the fourth set of memory arrays.

17. The memory component of claim 16, wherein accesses of a first rank by the controller access at least the first set of memory arrays and accesses of a second rank by the controller access at least the third set of memory arrays.

18. The memory component of claim 16, wherein the second memory integrated circuit is to, based on a third mode, use a third plurality of data I/O circuits to access the third set of memory arrays and a fourth plurality of data I/O circuits to access the fourth set of memory arrays, where the third plurality of data I/O circuits and the fourth plurality of data I/O circuits are disjoint sets of data I/O circuits.

19. The memory component of claim 18, wherein the third plurality of data I/O circuits is coupled with a first portion of the set of relay data I/O circuits and the second plurality of data I/O circuits is coupled with a second portion of the set of relay data I/O circuits, the first portion of the set of relay data I/O circuits and the second portion of the set of relay data I/O circuits being disjoint set of data I/O circuits.

20. The memory component of claim 19, wherein the controller is to access the first set of memory arrays and the third set of memory arrays via a first memory access channel and is to access the second set of memory arrays and the fourth set of memory arrays via a second memory access channel.
